(19) United States
(12) Patent Application Publication
(10) Pub. No.: US 2026/0152138 A1
(43) Pub. Date: Jun. 4, 2026

(54) CONTROL METHOD FOR A COMPRESSED AIR SUPPLY SYSTEM, CONTROL DEVICE AND VEHICLE

(71) Applicant: ZF CV Systems Europe BV, Brussels (BE)

(72) Inventors: Uwe Stabenow, Laatzen (DE); Jörg Meier, Hessisch Oldendorf (DE)

(21) Appl. No.: 19/459,302

(22) Filed: Jan. 26, 2026

Related U.S. Application Data
(63) Continuation of application No. PCT/EP2024/069596, filed on Jul. 11, 2024.

(30) Foreign Application Priority Data
Jul. 26, 2023 (DE) 10 2023 119 858.0

(51) Int. Cl. B60R 16/08; B01D 53/04; B01D 53/26; B60R 16/023; B60R 16/033; B60S 1/54; B60S 1/56

(52) U.S. Cl. CPC B60R 16/08; B01D 53/0446; B01D 53/0454; B01D 53/261; B60R 16/0231; B60R 16/033; B60S 1/54; B60S 1/56; B01D 2257/80; B01D 2259/40086; B01D 2259/4566

(57) ABSTRACT

A control method is for a compressed air supply system. The method includes: a control device receiving a supply demand, the control device activating a compressed air generator in order to provide compressed air at a compressed air connection when the control device receives a supply demand, the control device determining a freezing risk depending on environmental data and/or operating condition data for the compressed air generator, the control device activating a main line switching valve in order to block the pneumatic main line in a first operating mode in the event that the freezing risk is below a threshold value, and directing compressed air through the branch line to the compressed air supply connection in the filling direction in the first operating mode to supply the compressed air consumer. A control device is for carrying out the method. A vehicle includes such a control device.

### CROSS-REFERENCE TO RELATED APPLICATIONS

This application is a continuation application of international patent application PCT/EP 2024/069596, filed Jul. 11, 2024 designating the United States and claiming priority from German application 10 2023 119 858.0, filed Jul. 26, 2023, and the entire content of both applications is incorporated herein by reference.

### TECHNICAL FIELD

The present disclosure relates to a control method for controlling a compressed air supply system for a vehicle, to a control device for controlling a compressed air supply system, and to a vehicle with same.

### BACKGROUND

In vehicles, compressed air supply units are used to supply compressed air to compressed air consumers. For this purpose, compressed air is provided to the compressed air supply unit via the compressed air port by a compressed air provider such as a compressor or charger. The terms “compressor” and “charger” are used as synonyms in the present description and are usually used to describe engine-driven units that compress air. Conjointly with the compressed air supply unit, such a compressed air provider forms a compressed air supply system. Such a compressed air supply system is activated preferably via an electronic control device, that is, an electronic control unit (ECU). Such compressed air supply systems are also used in particular to supply compressed air to sensor cleaning devices as compressed air consumers. According to various embodiments, such compressed air supply systems are configured to provide compressed air with an operating pressure of 5 bar and a volumetric flow of preferably 30-100 l/min.

Sensor cleaning devices for vehicles are also known. A sensor cleaning device allows surfaces on a vehicle, in particular surfaces of sensors, to be cleaned using at least one cleaning fluid, for example compressed air. Cleaning sensor surfaces on the vehicle, in particular at regular intervals, means that sensors are less dirty and as a result function more reliably. A clean sensor surface thus advantageously increases the reliability of driver assistance functions and/or partially autonomous and/or autonomous driving functions of a vehicle. The safety of the vehicle, its occupants and other road users is thus advantageously increased by a sensor cleaning device.

As compressed air consumers, sensor cleaning devices that use compressed air as a cleaning fluid are connected to a compressed air supply unit. It is necessary to dry the compressed air provided by the compressed air supply unit for the sensor cleaning device, in order to prevent corrosion, damage caused by frost at below-freezing temperatures, and compromised functions on lines and at the sensor cleaning device. The substrate in the air dryer is fundamentally configured to adsorb moisture from the compressed air flowing through the air dryer, although the substrate can only adsorb moisture up to a maximum saturation point. So that the air dryer can continue to operate, the air dryer is therefore usually regenerated either at regular intervals or at the very latest when the saturation limit is reached. Regeneration refers in the present case to the dehumidification of the substrate used in the air dryer for drying purposes. In order to dehumidify the substrate, air which is drier compared to the substrate must then be conducted through the air dryer. This drier air binds some of the adsorbed moisture and thus reduces the degree of saturation of the substrate. The operating duration of the air dryer is limited by the saturation of the substrate situated in the air dryer. If the air dryer is not regenerated, when the substrate reaches maximum saturation it is necessary to replace the air dryer or the substrate situated in the air dryer.

A challenge faced by compressed air supply units for sensor cleaning devices is that the compressed air provided at the compressed air supply port cannot be returned to the compressed air supply unit and instead is discharged in order to clean the sensors. Thus, by contrast to known compressed air supply units, as disclosed for example in DE 10 2017 010 772 A1, the compressed air supply unit no longer contains any compressed air that has already been dried by the air dryer and can be used to regenerate the air dryer.

The operating duration of the compressed air supply unit for sensor cleaning devices therefore depends significantly on the operating duration of the air dryer and its degree of saturation. The necessary operating duration of such a compressed air supply unit has thus only been able to be realized to date by increasing the amount of substrate—that is, a larger air dryer. However, due to space limitations, such a solution is perceived as a disadvantage.

A compressed air supply system which overcomes these disadvantages is assigned a control device and the compressed air supply system further includes a compressed air provider for providing compressed air at a compressed air port, a pneumatic main line which has an air dryer for drying compressed air and conducting same to the compressed air supply port in a filling direction, and a branch line which branches off from the pneumatic main line upstream of the air dryer in the filling direction and rejoins it downstream of the air dryer in the filling direction. In the pneumatic main line of such a compressed air supply system, between the compressed air port and the air dryer there is a pneumatic switching valve configured to open the pneumatic main line to a pneumatic flow in the filling direction in a first operating mode and to close off the pneumatic main line in the filling direction in a second operating mode. A branch line, which branches off from the pneumatic main line upstream of the air dryer and rejoins the pneumatic main line downstream of the air dryer, provides a bypass via which compressed air can be conveyed in the direction of the compressed air supply port. The switching valve thus allows drying, as and when required, of the compressed air provided at the compressed air supply port in the first operating state and otherwise prevents this drying. In this way, the air dryer is “rested”, in a manner of speaking. Such a compressed air supply system utilizes the finding that extensive drying of the compressed air provided at the compressed air supply port is not necessary all of the time but rather appears to be appropriate or not appropriate depending on the weather, among other things.

### SUMMARY

It is an object of the disclosure specify a control method for controlling a compressed air supply system for a vehicle that overcomes at least one of the disadvantages known from the prior art. In particular, it is an object of the present disclosure is to specify a control method which makes it possible to control the drying as and when required of the compressed air that is to be provided at the compressed air supply port.

In a first aspect, the disclosure proposes a control method for achieving the object mentioned at the outset. The control method for a compressed air supply system of the type described above includes:
the control device receiving a supply requirement of the compressed air consumer,
the control device activating the compressed air provider, in particular an electric motor assigned to the compressed air provider, in order to provide compressed air at the compressed air port should the control device receive a supply requirement,
the control device determining a risk of freezing on the basis of information about the surrounding area and/or an operating state of the compressed air provider,
the control device activating a main-line switching valve in order to close off the pneumatic main line in a first operating mode should the risk of freezing be below a predefined limit value, and
conducting compressed air through the branch line to the compressed air supply port in the filling direction in the first operating mode to supply the compressed air consumer.

According to the disclosure, the risk of freezing is understood as meaning the risk of freezing of moisture contained in the compressed air provided at the compressed air supply port.

In the context of the disclosure, the filling direction refers to the direction of the compressed air, which is conducted though a line, from the compressed air port to the compressed air supply port. The pressurized line can be the pneumatic main line or a branch line configured to conduct compressed air to the compressed air supply port.

Such a control device preferably includes one or more communicating control units. Thus, for example, a first control unit can be configured to control the compressed air consumer, a second control unit can be configured to control the compressed air supply system, and a third control unit can be configured to control the compressed air provider. The communication between such control units allows a reliable exchange of data and control of the compressed air supply system and of the compressed air consumer and compressed air provider in combination.

Closing off the pneumatic main line as and when required in the first operating mode means that the air dryer does not become more saturated should the risk of freezing be below a predefined limit value. The predefined limit value can be selected on the basis of the safety requirements for any vehicle. For instance, a high degree of autonomous driving of a vehicle necessitates increased safety requirements. A lower degree of autonomous driving and associated more moderate safety standards make it possible to set a predefined limit value correspondingly higher in order to further slow the saturation of the air dryer. In the first operating mode, in which the main-line switching valve expediently closes off the pneumatic main line, no air that is to be dehumidified passes through the pneumatic main line to the air dryer in the filling direction. If, by contrast, the risk of freezing exceeds this predefined limit value, the control method provides that the pneumatic main line is specifically not closed off by the main-line switching valve and compressed air is conducted to the air dryer for drying purposes. This ensures that lines or the compressed air consumer are prevented from freezing due to moisture in the compressed air provided at the compressed air supply port. In particular, the disclosure utilizes the finding that there is virtually never a risk of freezing in some climatic zones. For example, if a vehicle is used in the tropics or subtropics, where the temperatures are well above freezing all year round, there is normally no risk of freezing and the main-line switching valve would close off the pneumatic main line in the first operating mode. If this vehicle is now moved, for example into the mountains, the control method according to the disclosure suddenly determines that, due to the change in the information about the surrounding area, there is an increased risk of freezing which would rule out operating the compressed air supply system in the first operating mode.

Preferably, the method further includes the steps of: the control device activating the main-line switching valve in order to open up the pneumatic main line in a second operating mode should the risk of freezing reach or exceed the limit value; and conducting compressed air through the pneumatic main line to the compressed air supply port in a filling direction on the basis of the supply requirement and the air dryer drying the compressed air in the second operating mode. Thus, in the second operating mode, the control method can provide dried compressed air at the compressed air supply port.

Activating a switching valve in order to close off a pneumatic line can be understood as meaning energizing and switching off, that is, the absence of energization, depending on the design of the valve in question. Accordingly, activating a switching valve in order to open up a pneumatic line can be understood as meaning energizing and switching off, depending on the design of the valve in question.

According to various embodiments, the control device is connected to a pneumatic assembly assigned to the compressed air supply port. According to various embodiments, the method further includes the control device controlling the pneumatic assembly on the basis of sensor signals from a temperature sensor assigned to the compressed air provider and/or on the basis of the supply requirement of the air dryer.

The pneumatic assembly preferably includes a controllable throttle valve configured to, in the second operating mode, throttle compressed air conducted to the compressed air supply port in the filling direction. The compressed air provided at the compressed air supply port can thus be throttled to a permissible or required supply pressure, ensuring safe operation of the compressed air consumer.

The throttle valve preferably has a variable flow cross section, with the control device controlling the throttle valve to change the flow cross section. The throttle valve influences the compressed air flow by changing the flow cross section in the pneumatic main line. If the valve reduces the flow cross section, this obstructs the flow of compressed air in the pneumatic main line, increasing the resistance to the compressed air flow. This in turn makes it possible to increase the pressure upstream of the throttle point. The method thus throttles the pressure to the supply pressure by activating the throttle valve and reducing the flow cross section in the region of the throttle valve, and the pressure of the compressed air is then relieved again. If the throttle valve is activated by the control device according to the method, for example in the first operating mode, in such a way that a maximum reduction in cross section occurs, compressed air is no longer directed to the supply port.

To reduce the volumetric flow, the throttle valve cooperates in particular with a pressure relief valve, such as a venting check valve located in the venting line, with the flow cross section in the throttle valve being reduced to a great enough extent for the back pressure upstream of the throttle valve to reach the pressure relief valve and provide a sufficient pressure to open the valve. The venting check valve preferably opens at a pressure of at least 0.5 bar. Such control of the throttle valve allows the input volumetric flow supplied at the compressed air port to be divided between the supply volume flow for supply at the compressed air port and an excess portion which is returned, counter to the filling direction, to regenerate the air dryer.

According to various embodiments, the pneumatic assembly includes at least one first check valve opening in the filling direction and a bypass line, which branches off downstream of the check valve and rejoins upstream of the check valve and has a second check valve opening in the return direction, that is, counter to the filling direction. According to various embodiments, the pneumatic assembly further includes a throttle valve which is located in the bypass line downstream of the second check valve in the return direction and is configured to throttle compressed air conducted to the air dryer counter to the filling direction. For this purpose, the throttle valve preferably has a throttle point with a variable flow cross section. The throttle valve preferably has a control pressure line and is configured to regulate the flow cross section depending on the control pressure. The control pressure line preferably joins the bypass line downstream of the throttle point in the return direction, that is, counter to the filling direction. The first check valve is preferably located in the pneumatic main line, the first check valve and the second check valve being located between the (first) air dryer and the compressed air supply port. As an alternative or in addition, the first check valve is preferably located in the (second) branch line, the first check valve and the second check valve being located between the second air dryer and the compressed air supply port. To be returned to the branch line or the pneumatic main line, the compressed air thus inevitably has to pass through the controllable throttle valve, which is configured to throttle the pressure of the compressed air flowing to the air dryer in question. This compressed air is then preferably conducted via a throttle downstream of the air dryer in the filling direction and its pressure is further relieved by the throttle. The accompanying relief in pressure of the compressed air allows the compressed air to absorb more moisture when the air dryer is regenerating.

Furthermore, the method preferably includes adding an additional compressed air source as and when required on the basis of the supply requirement and/or on the basis of a sensor signal from a temperature sensor associated with the compressed air provider. An additional compressed air source besides the compressed air provider is thus added. An additional compressed air source increases the amount of compressed air available, that is, the volumetric flow available, and makes it possible to react to variable system requirements. An increased supply requirement in relation to the supply volumetric flow may occur for example when all of the nozzles of a sensor cleaning device are to be supplied with compressed air. As a result of the fact that the control device can add an additional compressed air source, depending on this supply requirement, it is possible to react to such supply requirements, and a sufficient supply volumetric flow with the supply pressure for supplying all of the nozzles can be provided. Furthermore, the compressed air provider may have to be switched off in the event of imminent overheating. The addition of the compressed air source depending on the sensor signals from the temperature sensor monitoring the compressed air provider makes it possible to react to such imminent overheating and also allows the compressed air source to continue to maintain the operation of the compressed air supply system.

According to various embodiments, determining the risk of freezing further includes the control device determining and/or retrieving the information about the surrounding area. The information about the surrounding area can be determined directly for example via the control device via sensors or else can be retrieved via a signal line or data interface, such as in particular a bus, of an electrical system or another storage device. Retrieving the information about the surrounding area via the Internet or other communications services also lies within the scope of the disclosure. The information about the surrounding area preferably includes one, several or all of the following: a current temperature of the surrounding area, a current humidity of a surrounding area, a climatic zone, an average temperature, an average humidity of the surrounding area. The information about the surrounding area is preferably determined at a current location and/or along a route and/or at a destination.

Determining the information about the surrounding area preferably includes retrieving location information concerning the route and/or the destination from an electrical system connected via a data interface and/or from a navigation system. As an alternative or in addition, retrieving the information about the surrounding area includes retrieving location information concerning the route and/or the destination from an electrical system connected via a data interface and/or from a navigation system. The control device can thus also take into account future situations which will have an influence on the supply requirement and in particular the permissible humidity of the compressed air at the compressed air supply port. In the event of a forecast temperature below freezing at the destination, for instance, due to a future supply requirement that can be determined from this the pneumatic main line will be opened early to provide dry compressed air at the compressed air supply port. This affords predictive control and a control method with increased operational reliability.

The method preferably includes retrieving location information concerning the route and/or the destination and the control device retrieving information about the surrounding area assigned to the location information from a signal-transmittingly connected electrical system and/or a navigation system. Retrieving location information and information about the surrounding area, such as a temperature or humidity, makes it possible to determine forecast ambient temperatures and/or humidity. This enables predictive control of the compressed air supply system.

According to various embodiments, the temperature and/or the humidity include a current ambient temperature and/or humidity, the method including the control device retrieving the current temperature and/or humidity from at least one signal-transmittingly connected ambient temperature sensor and/or humidity sensor or from a signal-transmittingly connected electrical system. Retrieving the current temperature makes it possible to reliably identify a need for regeneration on the basis of the current ambient conditions. In particular, fluctuations with respect to, for instance, an average temperature or a forecast temperature are taken into account in this way. An ambient temperature sensor or a humidity sensor can detect such a temperature or humidity, respectively, in the immediate vicinity of the vehicle. An electrical system can also retrieve this temperature and/or humidity from signal-transmittingly connected ambient temperature sensors or humidity sensors, respectively, or can retrieve the temperature via in particular wireless data connections from meteorological stations in the surrounding area or from the Internet.

The control device preferably has a memory and is configured to retrieve information concerning the temperature and/or the humidity or to retrieve state variables while the air dryer is operating. According to various embodiments, the control device is configured to retrieve information from a dew point sensor in order to determine a risk of freezing.

According to various embodiments, the risk of freezing lies below the predefined limit value should at least one of the following conditions relating to the information about the surrounding area be met:
the ambient humidity lies below 2 g/m3,
the temperature of the surrounding area lies above 15° C.,
the dew point temperature of the surrounding area lies more than 15° C. below the ambient temperature,
the average temperature is at least 20° C.,
the average humidity is at most 0.5 g/m3 , in particular at most 0.25 g/m3,
the climatic zone is tropical or subtropical.

According to various embodiments, the operating state information includes one, several or all of the following:
an operating duration of the compressed air provider, in particular within a predefined period of time, preferably of the electric motor, the operating duration being monitored by the control device via a signal-transmitting connection, in particular via a CAN bus connection,
a temperature of the compressed air provider, in particular of the electric motor, the temperature being measured directly or indirectly by at least one sensor and monitored by the control device,
a pressure in the pneumatic main line when the compressed air provider is operating.

A dew point temperature of the surrounding area lying more than 15° C. below the ambient temperature allows the ambient air to cool down by 15° C. without condensation occurring.

The average temperature is a predefined average annual temperature, ascertained in particular by meteorological services, or an average monthly temperature. This means that temperatures do not need to be detected or retrieved continuously. The average humidity is a predefined average annual humidity, ascertained in particular by meteorological services, or an average monthly humidity. This means that the humidity does not need to be continuously detected or retrieved.

The temperature of the compressed air provided by the compressed air provider at the compressed air port depends considerably on the operating duration and the pressure in the pneumatic main line. If a certain operating duration is exceeded, the compressed air provided at the compressed air port will still have a sufficiently high temperature at the compressed air supply port even after being conducted through the branch line, and this therefore virtually rules out freezing of the lines or the compressed air consumer. In such a case, the control method determines a risk of freezing below the predefined limit value on the basis of the operating state, which is determined considerably by the operating duration of the compressed air provider. As an alternative or in addition, the operating state can also be measured directly or indirectly by at least one sensor directly determining the temperature of the compressed air transmitter, and thus be monitored by the control device. The control method according to the disclosure can also be used to reliably determine the risk of freezing on the basis of this temperature characterizing the operating state.

According to various embodiments, the risk of freezing lies below the predefined limit value should at least one of the following conditions relating to the information about the operating state be met:
the operating duration of the compressed air provider within 15 minutes is at least 5 minutes,
the temperature of the compressed air provider is at least 60° C.

With such a high operating duration, the temperatures of the compressed air provided are expected to be high enough to rule out a risk of freezing. The same applies to a temperature of the compressed air provider of 60° C. In these cases, the risk of freezing is so low that the compressed air supply system can be operated with high operational reliability in the first operating mode.

Furthermore, the method preferably includes activating a branch-line switching valve in order to close off the branch line in the filling direction should the risk of freezing exceed the predefined limit value. Closing off the branch line prevents compressed air that has not completely dried from reaching the compressed air supply port. This avoids mixing of the compressed air from the pneumatic main line and from the branch line.

By pre-filling the pneumatic main line, should the control device receive a supply requirement an increased supply of compressed air can be provided when the compressed air starts to be provided at the compressed air supply connection, for instance in order to allow the sensor cleaning device to remove heavy soiling.

According to a preferred embodiment, the branch line is a first branch line with a first branch-line switching valve and the compressed air supply system also has a second branch line with a second branch-line switching valve and a second air dryer. According to various embodiments, the control device monitors a degree of saturation of the first air dryer and preferably of the second air dryer, the method further including the steps of:
the control device activating the second branch-line switching valve in order to open up the second branch line in a third operating mode should the risk of freezing reach or exceed the limit value and the saturation level of the first air dryer reach a maximum degree of saturation,
conducting compressed air through the second branch line to the compressed air supply port in a filling direction on the basis of the supply requirement and the air dryer drying compressed air in the third operating mode. This makes it possible to further increase the operational readiness of the compressed air supply system and achieve an operational readiness of up to 100% even at temperatures below freezing. This is important in particular for autonomous vehicles, since the functional capability of sensors is crucial for the safety of occupants and the surrounding area. The control method according to the disclosure for a compressed air supply system of the type described above makes it possible to maintain a reliable supply of dried compressed air even when a saturation limit of a first air dryer is reached.

It should be understood that the branch-line switching valve is located at a branching point at which the branch line branches off from the pneumatic main line and can be in the form of a 3/2-way valve. The branch-line switching valve, in the form of a 3/2-way valve, thus combines the function of the main-line switching valve and the branch-line switching valve. The distribution of the compressed air partially dehumidified by the water separator can be controlled with just one switching valve.

According to various embodiments, the method includes the following step:
flushing the pneumatic main line and/or the branch line by way of compressed air provided at the compressed air port and draining the compressed air via the venting line, the compressed air preferably being dried by the air dryer, and flushing the pneumatic main line counter to the filling direction and/or flushing the branch line in the filling direction, and/or
flushing the compressed air consumer by way of compressed air provided at the compressed air port and preferably dried by the air dryer and draining the compressed air via the compressed air consumer.

Flushing the pneumatic main line and/or the branch line makes it possible to eliminate residues, in particular accumulations of water, in the lines and in particular to discharge air with an increased moisture content from the compressed air supply system to the venting port via the venting line. Flushing the compressed air consumer with dried compressed air ensures that moisture in the compressed air consumer is prevented from freezing during long periods of downtime, even when it was previously operated with only partially dehumidified or humid compressed air. If, by contrast, flushing is performed generally with compressed air that has not been dried by an air dryer, accumulations of moisture can be blown out into valves.

Flushing the pneumatic main line and/or the branch line makes it possible to eliminate residues in the lines and in particular to discharge air with an increased moisture content from the compressed air supply system to the venting port via the venting line.

According to various embodiments, the method includes the following step:
activating the main-line switching valve and the branch-line switching valve in order to pneumatically decouple the pneumatic main line and the branch line from the compressed air port. In particular, the air dryer located in the pneumatic main line is also pneumatically decoupled from the compressed air consumer. By pneumatically decoupling the pneumatic main line or the branch line from the compressed air port, the system is depressurized in an inactive mode in which there is no provision of compressed air at the compressed air supply port or regeneration of the air dryer. In this way, the air dryer does not become more saturated and the branch line and the pneumatic main line are protected against any later occurrences of frost-related damage. It is therefore taken into account that the ambient conditions may change, for example while a vehicle is parked. For example, night frost could otherwise cause frost damage, which is prevented in this way. According to various embodiments, the method further includes activating the venting valve in order to pneumatically decouple the venting line from the surrounding area. This also protects the venting line in the inactive mode.

According to various embodiments, the method includes activating a first stop valve, which is downstream of the first air dryer in the filling direction, in order to close off the pneumatic main line in the first operating mode should the risk of freezing lie below the predefined limit value, and/or activating a second stop valve, which is downstream of the second air dryer in the filling direction, in order to close off the second branch line in the first operating mode should the risk of freezing lie below the predefined limit value. The pneumatic main line is thus closed off both in the filling direction and counter to the filling direction in the first operating mode, protecting the air dryer against still-humid compressed air and avoiding continuing saturation of the air dryer.

In embodiments in which the air dryer in the pneumatic main line is a first air dryer, the stop valve is located correspondingly downstream of the first air dryer in the filling direction in the pneumatic main line. The air dryer or the first air dryer is thus pneumatically decoupled from the branch line. When the compressed air supply unit is operating in the first operating mode, in which the compressed air is provided at the compressed air supply port exclusively via the branch line, no still-humid compressed air reaches the air dryer and furthers its saturation. Such a stop valve is preferably a switchable stop valve, particularly preferably an electrically controllable 2/2-way valve. In addition, such a pneumatic decoupling of the air dryer from the branch line carrying humid compressed air makes it possible to predict the degree of saturation of the air dryer in question more exactly.

The control method preferably further includes activating the first branch-line switching valve and/or activating the second branch-line switching valve in order to close off the second branch line in the second operating mode and/or activating the first branch-line switching valve in order to close off the first branch line in a third operating mode, in which the compressed air is conducted via the second branch line. Thus ensures that, in the second or third operating mode, the compressed air reaches the compressed air supply port exclusively via the air dryer in question and does not mix for instance with the still-humid compressed air from the second branch line.

The control method preferably further includes the control device regulating, on the basis of the supply requirement, the supply pressure and/or the supply volumetric flow of the compressed air provided at the compressed air supply port. Thus, the control method expands the function of the control device in addition to simply receiving the supply pressure and/or the supply volumetric flow at the compressed air supply port by regulating the supply pressure and/or the supply volumetric flow at the compressed air supply port. The control device is signal-transmittingly connected to at least one pressure sensor located in the pneumatic main line in order to provide sensor signals and to a pressure regulator assigned to the pneumatic main line and/or to the compressed air port, the control device controlling the pressure regulator on the basis of the sensor signals. The pressure or the supply volumetric flow is therefore regulated on the basis of the pressure in the pneumatic main line, which connects the compressed air port to the compressed air supply port. Thus, the control device can respond directly to pressure fluctuations in the pneumatic main line.

In addition or as an alternative, the control device is preferably signal-transmittingly connected to the electric motor, in particular the BLDC electric motor, and configured to regulate a motor speed of the electric motor in order to provide compressed air with the supply pressure and/or the supply volumetric flow at the compressed air supply port. Thus, the supply pressure and/or the supply volumetric flow can optionally also be regulated by regulating the motor speed of the electric motor which drives the compressor. Such regulation of the motor speed also allows indirect pressure regulation due to the direct influence on the output of the compressed air provider. Further, the saturation of the air dryer is limited by the regulation of the motor speed or the pressure regulation in general, since the pressure regulation preferably limits the input pressure at the compressed air port to 5 bar.

Furthermore, the compressed air supply unit preferably further includes a compressor venting line with a compressor venting valve. The method preferably includes activating the compressor venting valve in order to vent a line volume between the compressed air provider and the branch-line switching valve and the main-line switching valve. This reduces the startup resistance for the compressor.

According to various embodiments, one, several or all of the following are in the form of normally closed solenoid directional control valves:
the at least one main-line switching valve,
the at least one branch-line switching valve,
at least one nozzle valve of a sensor cleaning device connected to the compressed air supply unit,
the at least one venting valve, and
the compressor venting valve,
the solenoid directional control valves having a coil for generating a magnetic force and an armature, which is movable by the magnetic force counter to a spring force acting in the direction of a valve seat, and being configured to be moved away from the valve seat counter to the spring force by energizing with an opening control current and to bear against the valve seat by energizing with a heating control current which is smaller than the opening control current, the coil being configured to heat the solenoid directional control valve when the heating control current is present. The possibility of heating the mentioned valves reduces the risk of frost damage to the pneumatic system as a whole. In addition to the sensor cleaning device and other compressed air consumers, this also relates in particular to the compressed air supply unit.

According to various embodiments, the method further includes energizing one, several or all of the following solenoid directional control valves selectively with an opening control current and a heating control current:
the at least one main-line switching valve,
the at least one branch-line switching valve,
at least one nozzle valve of a sensor cleaning device connected to the compressed air supply unit,
the at least one venting valve, and
the compressor venting valve.

The possibility of heating the mentioned valves reduces the risk of malfunctions of the pneumatic system as a whole as a result of freezing. In addition to the sensor cleaning device and other compressed air consumers, this also relates in particular to the compressed air supply unit. The use of the coil, which is present in any case, of the solenoid valves makes it possible to dispense with additional heating elements. It should be understood that heating of the solenoid valves is necessary, especially before opening, since they remain in the closed state for longer periods of time. Damage to the valve only occurs when a possibly frozen valve or its armature is moved. By heating the valve, which preferably takes place continuously during operation, energizing the solenoid valve before it actually opens prevents it from freezing.

A heatable nozzle valve reduces the risk of frost damage at temperatures close to freezing. The threshold value from which only compressed air dried by the air dryer is allowed to be conducted to the compressed air supply port is accordingly shifted to lower temperatures.

Furthermore, the risk of freezing is determined by the control device on the basis of the information about the surrounding area in such a way that, should the control device be configured to apply a heating control current, a reduced risk of freezing is determined. According to various embodiments, the risk of freezing lies below the predefined limit value should the temperature of the surrounding area be at least 0° C., in particular at least 5° C., and should the at least one nozzle valve and the at least one venting valve be heated by energizing with the heating control current. The operating range in which the provision of compressed air via the branch line of the compressed air supply system is sufficient can therefore be extended to lower temperatures.

In general, it is advantageous to individually determine the risks of freezing for the individual switching valves or groups of valves. The risk of freezing can be defined from low to high in the following order. The risk is measured by the probability of the switch valve coming into contact with a quantity of water that can cause freezing:
Switching valves of the compressed air consumer,
Main-line and branch-line switching valves,
Venting valves.

The heating control current is then applied for the switching valves or groups of valves in question in accordance with the ascertained risks of freezing.

In a second aspect, the disclosure achieves the object mentioned at the outset by a control device. According to the second aspect, the disclosure proposes a control device for controlling a compressed air supply system for a vehicle, in particular a passenger car. A control device is assigned to the compressed air supply system for supplying a compressed air consumer via a compressed air supply line and the compressed air supply system includes a compressed air provider for providing compressed air at a compressed air port, a pneumatic main line which has an air dryer for drying compressed air and conducting same to the compressed air supply port in a filling direction, and a branch line which branches off from the pneumatic main line upstream of the air dryer in the filling direction and rejoins it downstream of the air dryer in the filling direction. The control device is configured to receive a supply requirement of the compressed air consumer and to activate the compressed air provider and can be signal-transmittingly connected to the compressed air consumer and to the compressed air provider. Furthermore, the control device is configured to determine a risk of freezing on the basis of information about the surrounding area and/or information about the operating state of the compressed air provider and to activate a main-line switching valve in order to close off the pneumatic main line in a first operating mode should the risk of freezing lie below a predefined limit value.

The control device is thus configured in particular to carry out a control method according to the first aspect of the disclosure. Advantages and preferred embodiments which have been described in relation to the first aspect are thus likewise advantages and preferred embodiments of the control device according to the second aspect of the disclosure.

In a third aspect, the disclosure achieves the object mentioned at the outset by a vehicle. According to the third aspect, the disclosure proposes a vehicle, in particular a passenger car, which has a compressed air supply system for supplying a compressed air consumer via a compressed air supply port. The compressed air supply system includes a compressed air provider for providing compressed air at a compressed air port, a pneumatic main line which has an air dryer for drying compressed air and conducting same to the compressed air supply port in a filling direction, and a branch line which branches off from the pneumatic main line upstream of the air dryer in the filling direction and rejoins it downstream of the air dryer in the filling direction. Furthermore, the vehicle includes a control device according to the second aspect of the disclosure assigned to the compressed air supply system, and a compressed air consumer, in particular a sensor cleaning device connected to the compressed air supply port. Owing to such a control device, the vehicle adopts as its own the advantages described in relation to the first aspect and the second aspect of the disclosure. Preferred embodiments and advantages according to the first aspect of the disclosure are likewise preferred embodiments and advantages of the vehicle according to the third aspect of the disclosure, and vice versa.

According to various embodiments, the vehicle further includes at least one sensor and/or a data interface, preferably a bus, in particular CAN bus, which is signal-transmittingly connected to the control device and configured to provide sensor data and/or memory data in order to determine a degree of saturation, defined by at least one state variable, of the air dryer and/or a humidity. As a result, the controller can retrieve necessary information concerning the degree of saturation of the air dryer and/or a humidity or temperature either directly via at least one sensor or via a corresponding data interface. In particular, this information makes it possible to calculate or estimate the degree of saturation of the air dryer. The ambient humidity drawn in and compressed by the compressed air provider, in particular a compressed air transmitter, ultimately also influences the permissible moisture content of the compressed air provided at the compressed air port and consequently also the saturation of the air dryer.

Further, according to various embodiments, the vehicle further includes an electrical system which is connected to the control device via the data interface and is configured to provide one, several or all of the following data: Location information from a navigation system, memory data from an electrical-system memory, sensor information from at least one sensor connected to the electrical system, in particular an ambient temperature sensor and/or a moisture sensor and a compressed air sensor. The vehicle preferably further includes an electrical-system battery configured to provide a supply of current to the electrical system and/or the compressed air consumer and/or the control device and/or the compressed air provider. This means that a supply of current to the components of the vehicle that are relevant for the supply and control of the compressed air supply system is provided centrally via the electrical-system battery. The disclosure advantageously takes into account that, for example, the compressed air provider needs more energy to compress the drawn-in compressed air.

In the present case, sensor information includes a temperature that has been detected by a temperature sensor and/or a pressure that has been detected by a pressure sensor and/or a humidity that has been detected by a humidity sensor.

Correspondingly, a central supply of current to the compressed air consumer via the electrical system is also advantageous. The compressed air supply system itself or the electrically activatable pneumatic solenoid valves are preferably supplied with current via the control device. The pneumatic switching valves can preferably be activated by way of such a supply of current and by way of being switched off by the control device.

According to various embodiments, the control device is configured to determine, on the basis of the data provided, the current and/or forecast temperature of the surrounding area and/or the current and/or forecast humidity of the surrounding area at least at one of the following positions: at a current location, along a route and at a destination. A correspondingly configured control device thus allows the temperature and/or humidity of the surrounding area to be determined not only at a current location, but also predictively along the route or at a destination. This enables an anticipatory regeneration of the air dryer, taking into account future ambient conditions. Such ambient conditions can concern in particular low temperatures or a very high humidity. For instance, a high humidity of the surrounding area leads to increased saturation or low temperatures require the air dryer to be ready for operation.

### BRIEF DESCRIPTION OF DRAWINGS

The invention will now be described with reference to the drawings wherein:

FIG. 1 shows a perspective view of a compressed air supply system having an assigned control device according to the disclosure;

FIG. 2A schematically shows a vehicle having a compressed air supply system in a first operating mode, in a first embodiment;

FIG. 2B schematically shows the vehicle according to FIG. 2A having the compressed air supply system in a second operating mode, in a first embodiment;

FIG. 3 schematically shows a vehicle having a compressed air supply system in a first operating mode, in a second embodiment;

FIG. 4 schematically shows a vehicle having a compressed air supply system in a first operating mode, according to a third embodiment;

FIG. 5 shows a solenoid directional control valve for a vehicle according to FIG. 2A to 4;

FIG. 6A shows a first embodiment of a pneumatic assembly;

FIG. 6B shows a second embodiment of a pneumatic assembly;

FIG. 6C shows a third embodiment of a pneumatic assembly;

FIG. 6D shows a fourth embodiment of a pneumatic assembly;

FIG. 7 shows the sequence of a method for the control device 1300 of a compressed air supply system for a vehicle according to FIGS. 2A and 2B according to a first embodiment;

FIG. 8 shows the sequence of a method for the control device 1300 of a compressed air supply system for a vehicle according to FIG. 3 according to a second embodiment;

FIG. 9 shows the sequence of a method for the control device 1300 of a compressed air supply system for a vehicle according to FIG. 4 according to a third embodiment.

### DETAILED DESCRIPTION

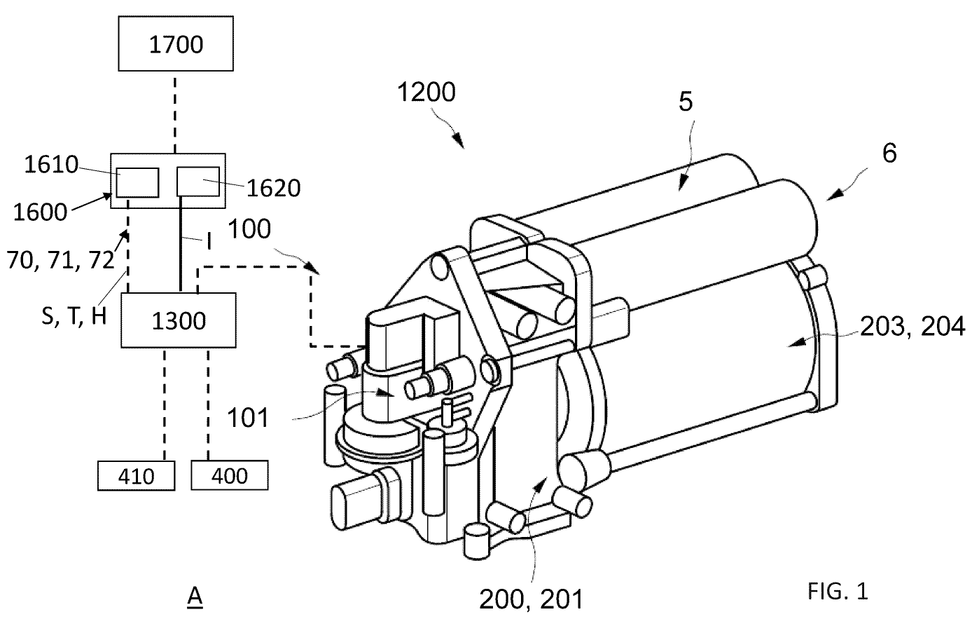

The compressed-air supply system 1200 according to FIG. 1 includes a compressed-air supply unit 100. The compressed air supply system 1200 further includes a compressed air provider 200 which preferably includes a compressor 201 driven by an electric motor 203.

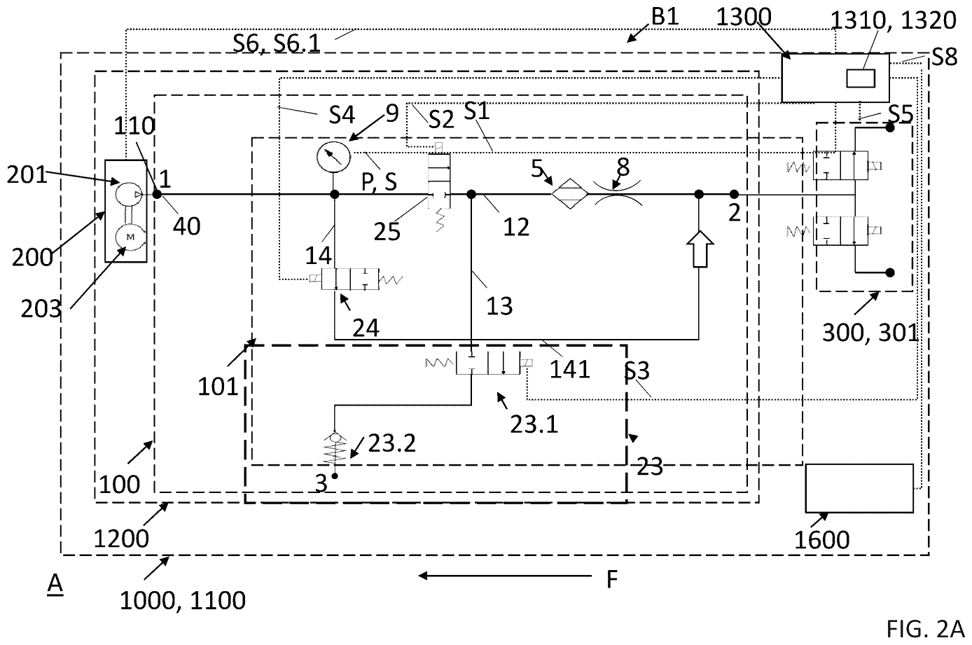

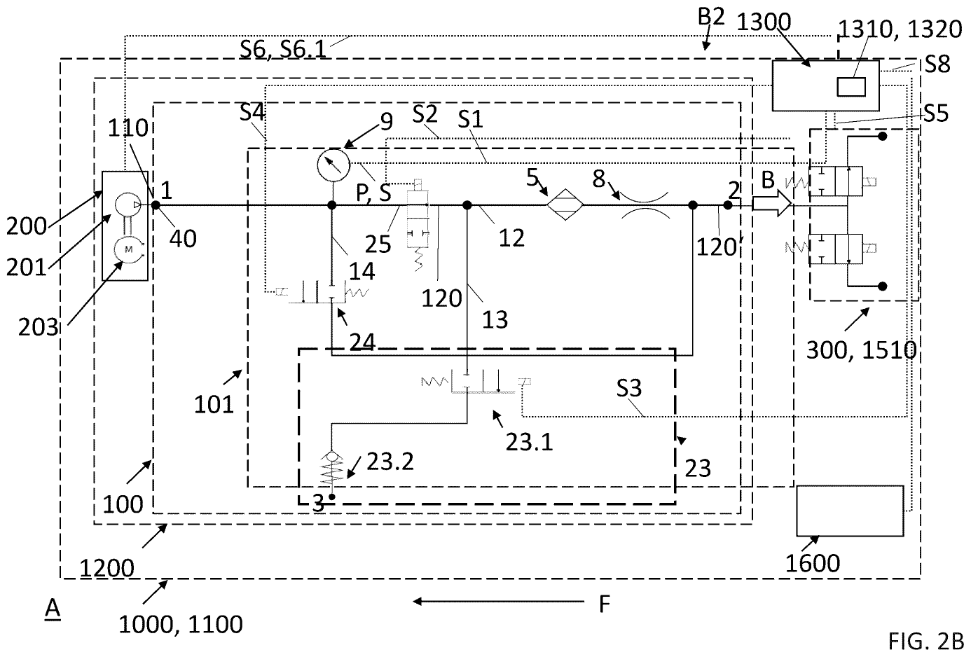

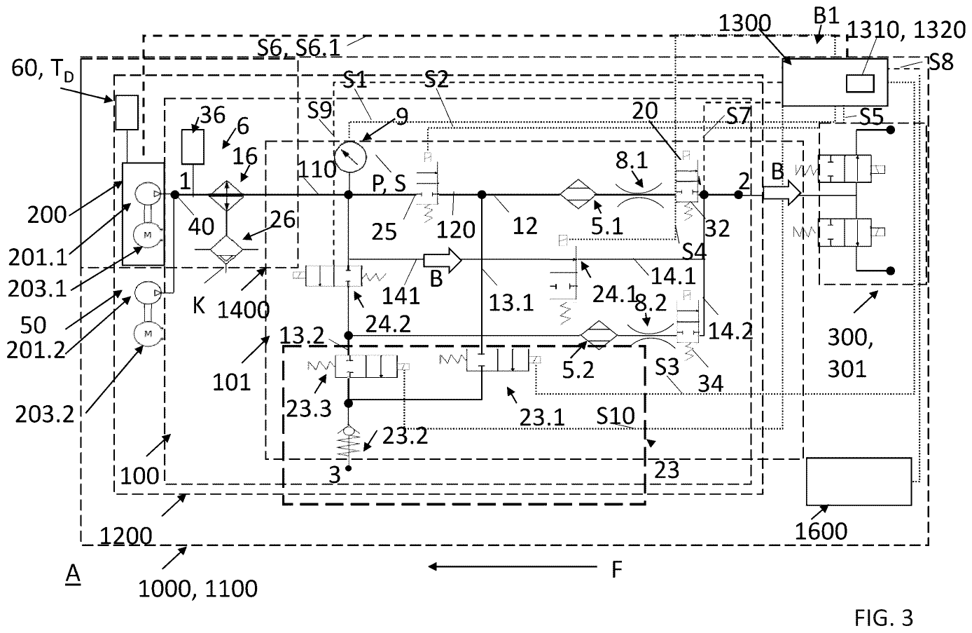

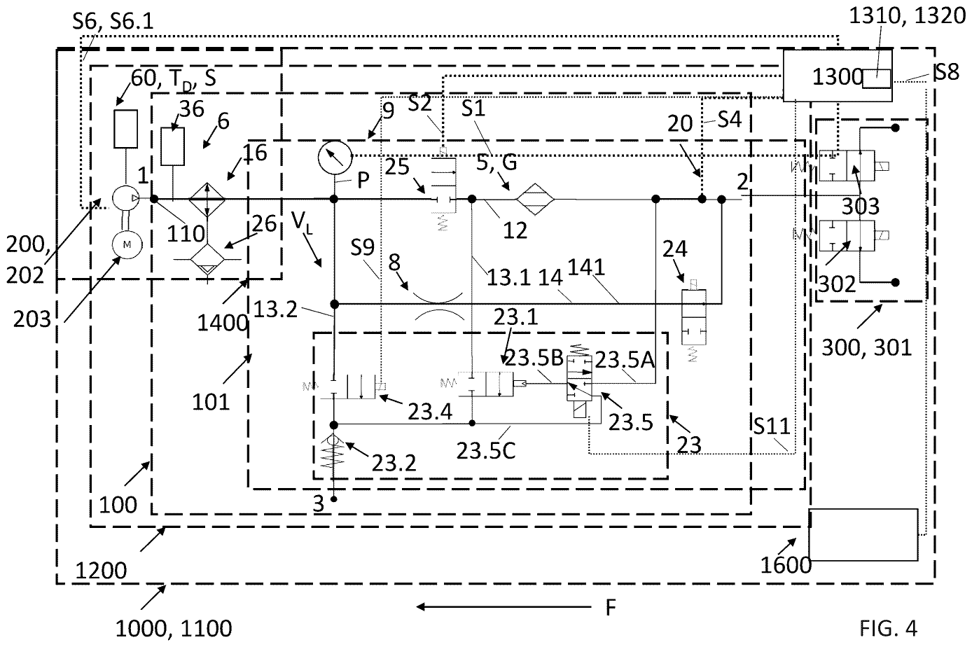

The compressed air supply system 1200 is connected to the compressed air provider 200 via a compressed air port 1 (cf. FIGS. 2A and 2B). The compressed air supply unit 100 includes an air dryer 5, which is located in a pneumatic main line 12 (cf. FIGS. 2A and 2B), and a water separator 6, which is located in flow terms between the air dryer 5 and the compressed air port 1 (cf. FIGS. 2A and 2B) (cf. FIG. 3 and FIG. 4). The compressed air supply unit 100 further includes a pressure control module 101 which has a number of main-line switching valves (not shown) for distributing the pressure within the compressed air supply unit 100.

The compressed air supply system 1200 is assigned a control device 1300 for controlling the compressed air supply system 1200.

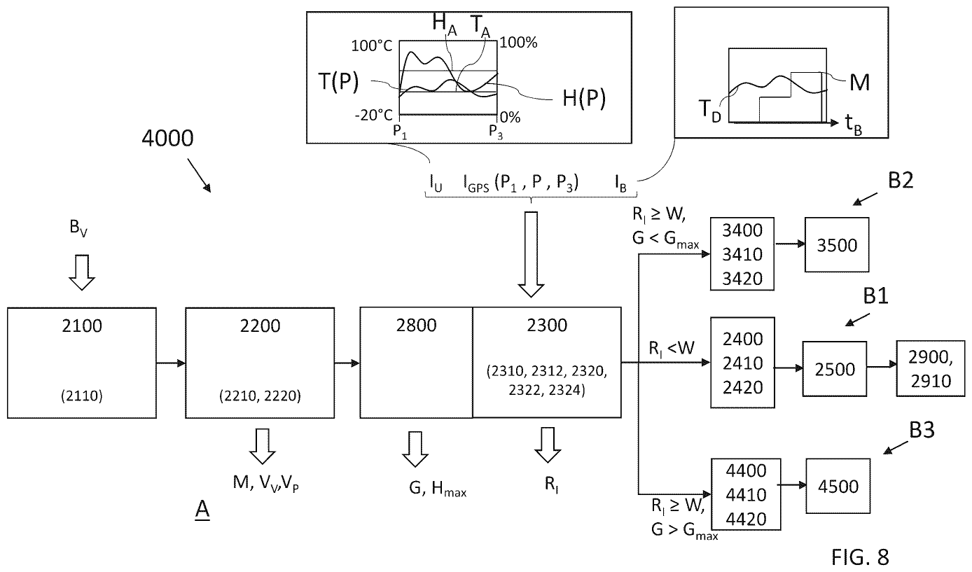

Signal-transmittingly connected to the control device 1300 are preferably an ambient temperature sensor 410 and a humidity sensor 400, which are configured to provide sensor information S, T, H in order to determine a degree of saturation G (cf. FIG. 8) of the air dryer 5 and/or a permissible moisture Hₘₐₓ (cf. FIG. 8). As an alternative or in addition, a dew point sensor (not shown) for determining the degree of saturation G (cf. FIG. 8) of the air dryer 5 can be connected to the control device.

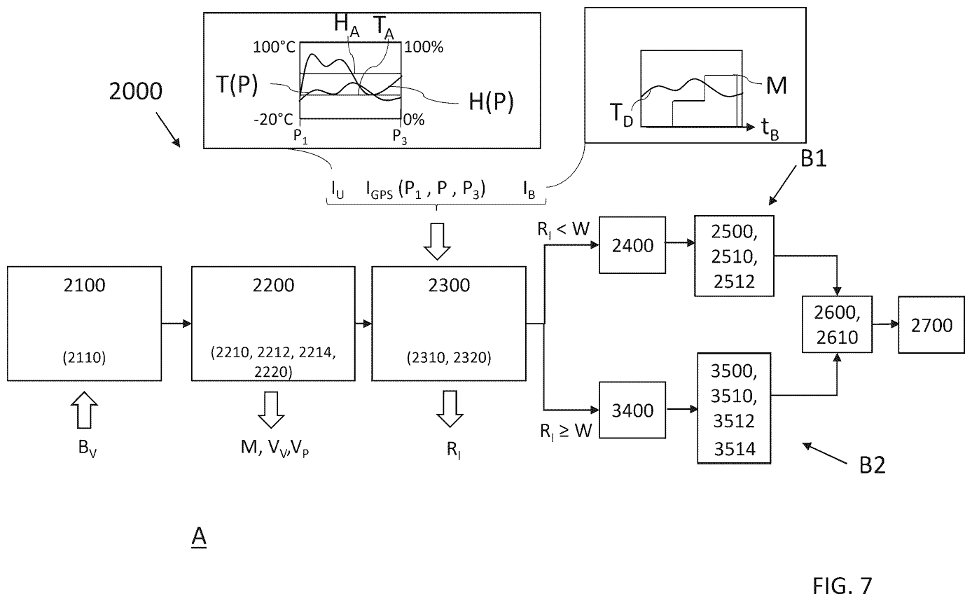

Also signal-transmittingly connected to the control device 1300 is preferably at least one data interface 70, preferably a bus 71, in particular a CAN bus 72, which is configured to provide stored or ascertained sensor information S, T, H in order to determine a degree of saturation G (cf. FIG. 8) of the air dryer 5 and/or a permissible moisture Hₘₐₓ (cf. FIG. 8). The data interface 70 connects the control device 1300 to an electrical system 1600 or a navigation system 1700. As an alternative, the connection to the navigation system 1700 can also be established indirectly via the electrical system 1600, the electrical system 1600 retrieving location information I_{GPS} (cf. FIG. 7) from the navigation system 1700. The electrical system 1600 preferably includes an electrical-system memory 1610, on which the sensor information S, T, H is stored.

The electrical system 1600 also has an electrical-system battery 1620 configured to supply current I to the electrical system 1600 and/or the compressed air provider 200 and/or the compressed air consumer 300 (cf. FIGS. 2A, 2B, 3 and 4) and/or the control device 1300.

The mode of operation of the control device 1300 will be described in detail in conjunction with the preferred embodiments of the vehicle 1000 that are shown in FIGS. 2A, 2B and 3.

FIG. 2A shows a vehicle 1000, in particular a passenger car 1100. The passenger car 1100 includes a compressed air supply system 1200 and also an electronic control device 1300 (ECU) and a compressed air consumer 300, which in the present case is a sensor cleaning device 301.

The compressed air supply system 1200 includes a compressed air supply unit 100 and a compressed air provider 200, which is connected to the compressed air supply unit 100 via a compressed air port 1. The compressed air provider 200 in the present case includes a compressor 201 with an electric motor 203.

The compressed air supply system 100 includes a compressed air port 1 for connection to the compressed air provider 200 (cf. FIG. 1) and a compressed air supply port 2 for connecting the compressed air consumer 300. The compressed air port 1 is connected to the compressed air supply port 2 via a pneumatic main line 12. A venting line 13 also branches off from the pneumatic main line 12 to a venting port 3, which is configured for venting the pneumatic main line 12. The compressed air supply unit 100 moreover has an air dryer 5, which is located in the pneumatic main line 12. The air dryer 5 is configured for drying the compressed air 110 provided at the compressed air port 1 and conducted through the pneumatic main line 12 in a filling direction B (not shown; cf. FIG. 2B).

The compressed air supply unit includes a venting valve assembly 23. A venting valve 23.1 of the venting valve arrangement 23 is arranged in the venting line 13, this venting valve preferably being an electrically controllable 2/2-way directional control valve. Also located downstream of the venting valve 23.1 in the direction of the venting line 3 is preferably a venting check valve 23.2 of the venting valve assembly 23, this venting check valve opening, preferably under pressure control, in the direction of the venting port 3. When the venting valve 23.1 is open, the venting check valve 23.2 thus preferably opens the venting line 13 as a result of the compressed air located in the venting line 13. At the same time, the venting check valve 23.2 prevents an ingress of moisture via the venting line 13. It should also be understood here that the venting line 13 can branch off from the main line 12 at any desired position, but preferably between the main-line switching valve 25 and the air dryer 5.

Advantageously, the compressed air supply unit 100 further includes a throttle 8. The throttle 8 is preferably downstream of the air dryer 5 in the filling direction B. The throttle 8 is configured to relieve the pressure of the compressed air returned, if appropriate, for the purpose of regenerating the air dryer 5.

A branch line 14 further branches off from the pneumatic main line 12 upstream of the air dryer 5 and rejoins the pneumatic main line 12 between the air dryer 5 and the compressed air supply port 2.

A pneumatic switching valve 25 is also located in the pneumatic main line 12, downstream of the branching-off branch line 14 and upstream of the air dryer 5 in the filling direction B (cf. FIG. 2B). The control device 1300 is configured to activate the main-line switching valve 25 in order to selectively open up and close off the pneumatic main line downstream of the branching-off branch line 14. According to various embodiments, the compressed air supply unit 100 further includes a branch-line switching valve 24 located in the branch line 14. The control device 1300 is configured to activate the branch-line switching valve 24 in order to selectively open up and close off the branch line 14. Furthermore, the control device 1300 is configured to activate the venting valve 23.1 in order to selectively open up and close off the venting line 13. The compressed air supply unit 100 has the pressure control module 101 shown in FIG. 1. The pressure control module 101 is preferably assigned the main-line switching valve 25, the branch-line switching valve 24 and the venting valve assembly 23 the venting valve 23.1.

The branch-line switching valve 24 can be provided merely as an option, it also being possible to operate the compressed air supply unit only with the main-line switching valve 25 and the venting valve 23.1, in particular the venting valve assembly 23.

Furthermore, the compressed air supply unit 100 includes a pressure sensor 9 located in the pneumatic main line 12. The pressure sensor 9 is configured to detect an input pressure P in the pneumatic main line 12, that is, that pressure of the humid compressed air 110 that is provided at the compressed air port 1, and provide a sensor signal S. The pressure sensor 9 is signal-transmittingly connected via a first signal line S1 to the control unit 1300, which is thus configured for monitoring the input pressure P.

The control device 1300 is further connected to the main-line switching valve 25 via a second signal line S2 and to the venting valve 23.1 via a third signal line S3. The branch-line switching valve 24 is preferably connected to the control device 1300 via a fourth signal line S4.

The control device 1300 is further connected to the compressed air consumer 300 via a fifth signal line S5.

The control device 1300 is further connected to the compressed air provider 200 via a sixth signal line S6. The control device 1300 is configured to monitor an operating duration t_{B} of the compressed air provider 200, which in the present case includes a compressor 201 with an electric motor 203. Furthermore, the control device 1300 is configured to monitor a motor speed M as information I_{B} about the operating state (cf. FIG. 7) of the electric motor 203. The electric motor 203 is preferably a BLDC electric motor 204 (cf. FIG. 1).

The signal lines S1, S2, S3, S4, S5, S6 can be either wired or wireless. According to various embodiments, the signal lines S5, S6 each include a data interface, in particular a bus or CAN bus. The signal lines S2, S3 and S4 can preferably also merely be electrical lines by way of which the control device 1300 activates the main-line switching valve 25, the branch-line switching valve and the venting valve 23.1 by energizing them or switching them off.

Furthermore, the control device 1300 is preferably configured to regulate a supply pressure P_{V} and/or a supply volumetric flow V_{V} of the compressed air 120′ provided at the compressed air supply connection 2 (cf. FIG. 2B). To regulate the supply pressure P_{V} and/or the supply volumetric flow V_{V}, the control device 1300 is signal-transmittingly connected to the pressure sensor 9 located in the pneumatic main line 12, the pressure sensor 9 being configured to detect the input pressure P in the pneumatic main line 12. According to various embodiments, the compressed air port 1 is further assigned a pressure regulator 40 (cf. FIG. 3) and the control device 1300 is configured to activate the pressure regulator 40 in order to regulate the supply pressure P_{V} and/or the supply volumetric flow V_{V} on the basis of the sensor signals S from the pressure sensor 9 (cf. FIG. 7-9).

As an alternative or in addition, the control device 1300 is connected to the electric motor 203 via the sixth signal line S6 and is configured to provide compressed air 120′ with the supply pressure P_{V} and/or the supply volumetric flow V_{V} at the compressed air port 1 and to regulate a motor speed M of the electric motor 203.

The vehicle 1000 further includes an electrical system 1600, which is signal-transmittingly connected to the control device 1300 via an eighth signal line S8.

FIG. 2A shows the compressed air supply system 1200 in a first operating mode B1. In the first operating mode B1, the control device 1300 is configured to activate the main-line switching valve 25 in order to close off the pneumatic main line 12. The main-line switching valve 25 is in the present case in the form of a normally closed 2/2-way directional control valve, so that the main-line switching valve 25, when de-energized, closes off the pneumatic main line 12. The compressed air 110 provided at the compressed air port 1 is thus conducted exclusively via the branch line 14 in the filling direction B, that is, from the compressed air port 1 to the compressed air supply port 2. The control device 1300 is further configured to activate the venting valve 23.1, which is also preferably in the form of a normally closed 2/2-way directional control valve, in the first operating mode B1 in order to close off the venting line 13. Therefore, in the first operating mode B1, no compressed air flows through the air dryer 5 in the filling direction B, and thus the air dryer does not become more saturated. The control device 1300 is configured to correspondingly activate the main-line switching valve 25 should a risk of freezing R_{I} (cf. FIG. 7-9) lie below a predefined limit value W (cf. FIG. 7-9), the control device 1300 being configured to determine this risk of freezing R_{I} (cf. FIG. 7-9). In other words, the control device 1300 activates the main-line switching valve 25 should it be highly likely that the freezing of the residual moisture in the compressed air that is to be provided at the compressed air supply port 2 can be ruled out, so it is not necessary for the air dryer 5 to dehumidify this compressed air.

FIG. 2B shows the compressed air supply system 1200 in a second operating mode B2. The main-line switching valve 25 is configured to open the pneumatic main line 12 to a flow in the filling direction B as a result of being activated by the control device 1300, so that compressed air 110 is conducted in the pneumatic main line 12 from the compressed air port 1 to the air dryer 5 and can be dried by the air dryer to form compressed air 120. The dried compressed air 120′ then passes through the throttle 8 and is provided at the compressed air supply port 2. The control device 1300 is configured to correspondingly activate the main-line switching valve 25 should a risk of freezing R_{I} (cf. FIG. 7-9) reach or exceed a predefined limit value W (cf. FIG. 7-9), the control device 1300 being configured to determine this risk of freezing R_{I} (cf. FIG. 7-9). In this case, it is necessary for the air dryer 5 to dry the compressed air that is to be provided at the compressed air supply port 2 in order to reliably prevent freezing of the residual moisture in the compressed air for example inside the compressed air consumer 300.

According to various embodiments, the branch-line switching valve 24 is provided in the branch line 14, the control device 1300 in the second operating mode B2 being configured to activate the branch-line switching valve 24 in order to close off the branch line 14. If the branch line 14 does not have a branch-line switching valve 24, in the second operating mode B2 a compressed air flow including dried compressed air 120′ from the pneumatic main line 12 and humidified compressed air 141 (cf. FIG. 4) from the branch line 14 is provided at the compressed air supply port 2.

The venting valve 23.1 is also configured in the second operating mode B2 to close off the venting line 13.

FIG. 3 shows a second embodiment of the vehicle 1000 according to the disclosure. In this case, identical or similar components have identical reference signs and reference is made to the description of the first embodiment, which is shown in FIGS. 2A and 2B.

FIG. 3 shows the vehicle 1000 in the first operating mode B1. The compressed air supply system 1200 preferably includes a water separator 6 located in the pneumatic main line 12 between the compressed air port 1 and the air dryer 5. The water separator 6 includes a condensation dryer 16 and a separating member 26 for separating condensate K from the compressed air 110 provided at the compressed air port 1. According to various embodiments, the water separator 6 is located in a front region 1400 of the vehicle 1000, so that the headwind assists the cooling of the compressed air 110 provided at the compressed air port 1 for the purpose of condensing the moisture. According to various embodiments, the water separator 6 further includes a ventilation device 36, which is configured to additionally cool the compressed air provided at the compressed air connection 1 in order to improve the degree of condensation and to remove an increased amount of condensate K from the compressed air 110 provided.

Furthermore, in the embodiment shown, the branch line 14.1 is a first branch line in which a first branch-line switching valve 24.1 is preferably located. The compressed air supply unit 100 further includes a second branch line 14.2 between the compressed air port 1 and the main-line switching valve 25, this second branch line branching off from the pneumatic main line 12 and preferably having a second branch-line switching valve 24.2. Furthermore, the air dryer 5.1 in the pneumatic main line 12 is preferably a first air dryer 5.1 and a second air dryer 5.2 is located in the second branch line 14.2. The second branch-line switching valve 24.2 is preferably connected to the control device 1300 via a ninth signal line S9. According to various embodiments, the venting line 13.1 is a first venting line and preferably a second venting line 13.2 with a second venting valve 23.3 branches off from the second branch line 14.2 between the second branch-line switching valve 24.2 and the second air dryer 5.2. The second venting valve 23.3 is preferably connected to the control device 1300 via a tenth signal line S10.

In the first operating mode B1 shown, as a result neither the first air dryer 5.1 nor the second air dryer 5.2 is used for drying the compressed air 110 provided at the compressed air port 1. Instead, the main-line switching valve 25 closes off the pneumatic main line 12 in the filling direction B and the second branch-line switching valve 24.2 closes off the second branch line 14.2 in the filling direction B. If a first branch-line switching valve is located in the first branch line 14.1, it is activated in the first operating state B1 by the control device in order to open up the first branch line 14.1. Compressed air 141 is thus conducted to the compressed air supply port 2 via the first branch line 14.1 in the filling direction B should the risk of freezing R_{I} determined by the control device 1300 lie below the predefined limit value W (cf. FIG. 7-9) and it be highly likely that the freezing of the residual moisture in the compressed air provided at the compressed air supply port 2 can be ruled out.

The second embodiment of the vehicle 1000 shown according to FIG. 3 differs from the first embodiment in that the compressed air provider 200 includes a first compressor 201.1 with a first electric motor 203.1 and further provided is an additional compressed air source 50, which includes a second compressor 201.2 with a second electric motor 203.2. The compressed air supply system 1200 preferably further includes a temperature sensor 60 which is signal-transmittingly connected to the control device 1300 and intended to monitor the temperature T_{D} of the compressed air provider 200. The control device 1300 is configured to, depending on the monitored temperature of the compressed air provider 200, switch on the second compressed air source 50 and preferably switch off the compressed air provider 200 as and when required. In this way, imminent overheating of the compressed air provider 200 can be detected at an early stage and operation can be maintained. Furthermore, the control device 1300 is configured to take the supply requirement B_{V} of the compressed air consumer 300 as a basis to switch on the second compressed air source 50 as and when required.

According to various embodiments, in FIG. 3, it is further possible for a first stop valve 32 to be downstream of the first air dryer 5.1 in the filling direction and a second stop valve 34 to be downstream of the second air dryer 5.2 in the filling direction B. The stop valves 32, 34 allow the air dryer 5.1, 5.2 to be pneumatically decoupled from the branch line 14.1, so that the air dryer does not become more saturated.

FIG. 4 shows a third embodiment of the vehicle 1000. In order to avoid repetitions, reference is made to the description of the vehicle 1000 according to the first embodiment in FIGS. 2A and 2B and only differences will be discussed. Identical or similar components have identical references in this case.

The third embodiment of the vehicle 1000 shown differs from the first embodiment in that the throttle 8, instead of being located in the pneumatic main line 12, is now located in the branch line 14 upstream of the branch-line switching valve 24. The throttle 8 relieves the pressure of the compressed air 141 provided at the compressed air port 1 at the start of the branch line 14, as a result of which the compressed air 141′ is drier due to the lower air pressure. This protects the branch line 14 and the branch-line switching valve 24 located therein against frost damage. At the same time, if the compressed air 141 is returned through the pneumatic main line 12 counter to the filling direction B, the throttle 8 brings about the pressure relief necessary for regenerating the air dryer 5.

Furthermore, a main-line switching valve 25 is located in the pneumatic main line 12.

The venting valve assembly 23 has a control valve 23.5 in the form of a 3/2-way solenoid valve. Furthermore, the venting valve 23.1 is configured as a pneumatically actuable venting valve 23.1. The control valve 23.5 can be activated via electrical control signals in the form of a voltage and/or current signal. When activated by the control device 1300 via an eleventh signal line S11, the control valve 23.5 can be transferred from a normally closed position to a pneumatically open position (not shown), in which a pressure derived from the pneumatic branch line 14 via a pneumatic control line 23.5A is transmitted via a bypass 23.5B for the purpose of pneumatically controlling the controllable venting valve 23.1.

In the closed state, the control valve 23.5 disconnects the control line 23.5A and is pneumatically connected to the venting port 3 via a further pneumatic line 23.5C.

The venting line 13.1 here is a first venting line 13.1 and the compressed air supply unit 100 further includes a compressor venting line 13.3. The compressor venting line 13.3 branches off from the pneumatic main line 12 upstream of the main-line switching valve 25 in the filling direction B. The venting valve assembly 23 has a compressor venting valve 23.4 in the compressor venting line 13.3. Via the compressor venting line 13.3, a line volume V_{L} between the compressed air provider 200, in the present case preferably a compressor 202, and the branch-line switching valve 24 and the main-line switching valve 25 can be vented. This reduces the startup resistance for the compressor 202.

The control valve 23.5, the compressor venting valve 23.4 and the branch-line switching valve 24 and the main-line switching valve 25 are in the present case in the form of solenoid valves, in particular normally closed solenoid valves.

According to various embodiments, in the embodiments according to FIGS. 2A, 2B, 3 and 4, the compressed air supply system 1200 further includes a temperature sensor 60 for monitoring the temperature of the compressed air provider 200, the temperature sensor 60 being signal-transmittingly connected to the control device 1300 and being configured to provide sensor signals S.

The compressed air consumer 300, which here is a sensor cleaning device 301, further includes a first nozzle valve 302 and a second nozzle valve 303. The nozzle valves 302, 303 are also in the form of solenoid valves, in particular normally closed solenoid directional control valves.

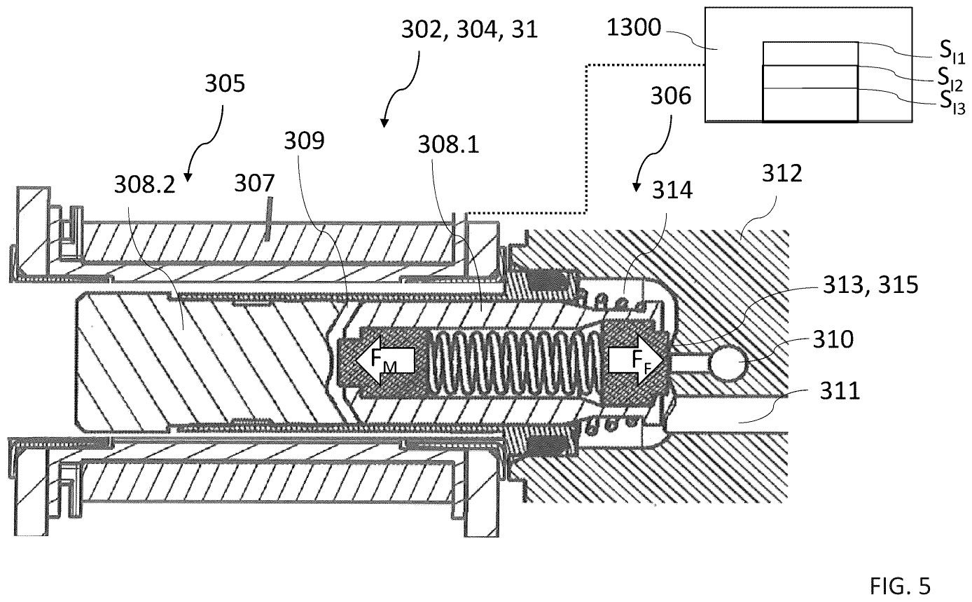

Such a solenoid directional control valve is shown by way of example in FIG. 5 on the basis of a possible design of a nozzle valve 302. The nozzle valve 302 is a normally closed 2/2-way valve 304. The nozzle valve 302 includes a magnetic part 305 and a pneumatic part 306. The magnetic part 305 has an electric coil 307, an armature 308.1, which is actuable magnetically and under the influence of a spring force, and a fixed magnetizable core 308.2. An air gap 309, which defines the possible travel of the armature 308.1, is formed between the armature 308.1 and the core 308.2.

The pneumatic part 306 includes a first compressed air passage 310 and a second compressed air passage 311. The pneumatic part 306 further includes a valve plunger part 312, which has an impact surface 313 facing in the direction of the armature 308.1.

The nozzle valve 302 further includes a valve spring 314, which is configured to apply a spring force F_{F} in the direction of the valve plunger part 312, in particular the impact surface 313, to the armature 308.1. When the nozzle valve 302 is open, the armature 308.1 is spaced from a valve seat 315 of the pneumatic part 306.

The armature 308.1 is movably mounted in the magnetic part 305 and the pneumatic part 306. By energizing of the electric coil 307, the latter generates a magnetic field with a magnetic force F_{M}. At the core 308.2, the resulting magnetic field generates a magnetic pole, which attracts the armature 308.1 and moves the latter away from the valve seat 315 counter to the spring force F_{F} of the valve spring 314, so that the first compressed air passage 310 and the second compressed air passage 311 are fluid-conductively connected. The magnitude of the magnetic force F_{M} depends on the applied control current S_{I} which is provided by the control device 1300. The opening control current S_{I1} required for opening the nozzle valve 302 is greater than the holding control current S_{I2} required for holding the nozzle valve 302 in the open position. The magnitude of the force that a magnetic field induced by the coil 307 applies to the armature 308.1 at a constant current depends on the distance of the armature 308.1 relative to the magnetic field, that is, on the size of the air gap 309 between the armature 308.1 and the core 308.2. At a larger distance, a weaker magnetic field is therefore in effect. In the closed position, the armature 308.1 is initially at a greater distance from the magnetic field, so that an increased current, namely an opening control current S_{I1}, is provided. The opening control current S_{I1} required for opening the nozzle valve 302 refers to the current which is required for reducing the distance of the armature 308.1 from the core 308.2 and thus for reducing the air gap 309. As soon as the armature 308.1 moves to an open position, its distance from the magnetic field is reduced and a lower holding control current S_{I2} is sufficient for holding the armature 308.1 in this position. The control device 1300 is moreover preferably configured to apply a heating control current S_{I3} to the nozzle valve 302, the heating control current being smaller than the opening control current S_{I1}, in particular also smaller than the holding control current S_{I2}, such that the nozzle valve 302 is heated by the generated magnetic field in the closed state.

The control device 1300 shown in FIG. 2A to 4 is configured to open the compressor venting valve 23.4 and the branch-line switching valve 24, the main-line switching valve 25 and the nozzle valves 302, 303 and to provide a control current S_{I} at the level of the opening control current S_{I1} (cf. FIG. 5). Furthermore, the control device 1300 is also configured to apply a heating control current S_{I3} to one, several or all of these valves.

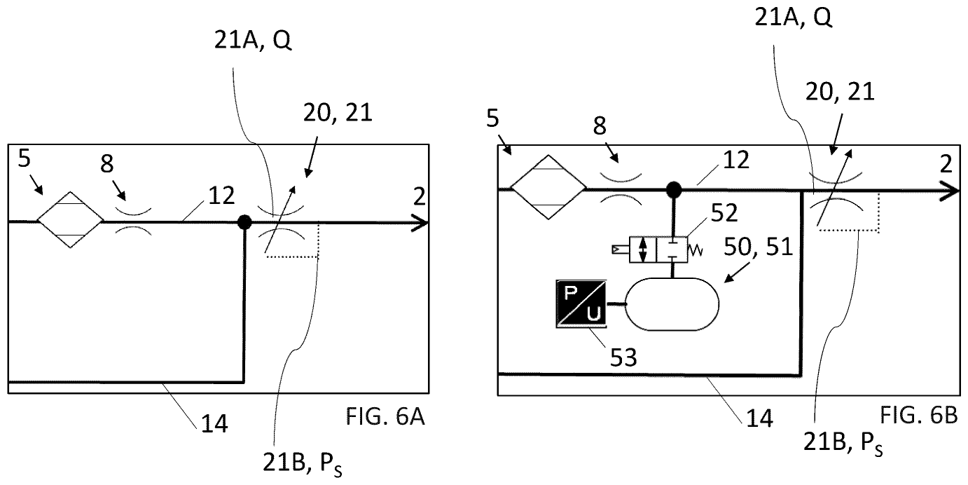

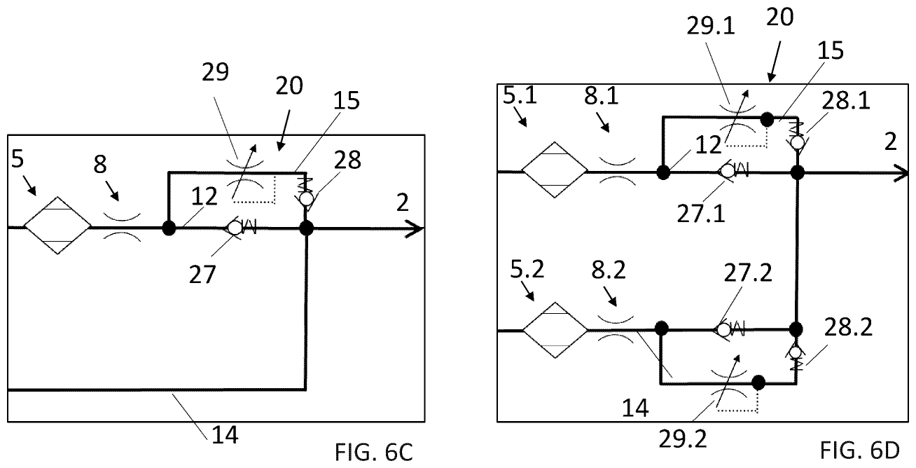

FIG. 6A to 6d show a detail of the compressed air supply system 1200 according to FIGS. 2A and 2B, with various embodiments of the pneumatic assembly 20 being shown in detail. In order to avoid repetitions and to explain the functioning of the pneumatic assembly 20, reference is therefore made to the description of FIGS. 2A and 2B.

The pneumatic assembly 20 according to FIG. 6A includes a controllable throttle valve 21, which is configured to throttle compressed air conducted in the filling direction B to the compressed air supply port 2. The throttle valve 21 has a variable flow cross section Q and is connected in terms of control, that is, signal-transmittingly, to the control device 1300. The throttle valve 1300 is configured to activate the throttle valve 21 for the purpose of changing the flow cross section Q, in order to throttle the pressure in the pneumatic main line 12 to a supply pressure that is to be provided of in particular 5 bar. The throttle valve 21 has a throttle point 21A with a variable flow cross section Q, the throttle valve 21 having a control pressure line 21B for conducting a control pressure P_{S} and being configured to regulate the flow cross section Q on the basis of the control pressure P_{S}.

Analogously to the embodiment shown in FIG. 6A, the pneumatic assembly 20 according to FIG. 6B includes a controllable throttle valve 21. Furthermore, the compressed air supply system 1200 includes an additional compressed air source 50 besides the compressed air provider 200, which includes a compressor 201 and an electric motor 203 in FIG. 3. The compressed air source 50 includes a reservoir 51 for storing compressed air, the reservoir 51 being connected to the pneumatic main line 12 via a reservoir switching valve 52. The compressed air source 50 is configured to be connected to the pneumatic main line 12 as and when required by activation of the reservoir switching valve 52. The control device 1300 (cf. FIG. 2A or 2B) is signal-transmittingly connected to a reservoir pressure sensor 53 and is configured for activating the reservoir switching valve 52. Activation of the reservoir switching valve 52 allows a defined amount of compressed air to be directed into the pneumatic main line 12, with the control device 1300 regulating the amount of pressure via the signals from the reservoir pressure sensor 53 and/or via the reservoir switching valve 52.

The pneumatic assembly 20 according to FIG. 6C includes a pair of check valves 27, 28 which open in opposite directions and are connected in parallel in terms of flow, the pair being located between the air dryer 5 and the compressed air supply port 2.

The pair of check valves 27, 28 includes a first check valve 27 which opens in the filling direction B and is located in the pneumatic main line 12, and, furthermore, a second check valve 28 opening in the return direction R. The second check valve 28 is located in a bypass line 15, which forms a bypass around the first check valve 27. The pneumatic assembly 20 further includes a return throttle valve 29 which is downstream of the second check valve 28 in the return direction R.

The pneumatic assembly 20 according to FIG. 6D is configured for use with compressed air supply units, such as those shown in FIG. 3, that is, for compressed air supply units having two air dryers 5.1, 5.2. A first pair of check valves 27.1, 28.1 which open in opposite directions, are connected in parallel in terms of flow and have a corresponding return throttle valve 29.1, as has been described with respect to the embodiment according to FIG. 6C, is assigned to the first air dryer 5.1 and located between the first air dryer 5.1 and the compressed air port 2.

A second pair of check valves 27.2, 28.2 which open in opposite directions, are connected in parallel in terms of flow and have a corresponding second return throttle valve 29.2, as has been described with respect to the embodiment according to FIG. 6D, is assigned to the second air dryer 5.2 and located between the second air dryer 5.2 and the compressed air port 2.

FIG. 7 schematically shows the sequence of a control method 2000. The control method 2000 includes, in a first step 2100, the control device 1300 receiving a supply requirement B_{V} of the compressed air collector 300. The receiving of the supply requirement in step 2100 preferably includes the control device 1300, in step 2110, determining or receiving a supply pressure V_{P} and/or a supply volumetric flow V_{V} on the basis of the supply requirement B_{V} of the compressed air that is to be provided at the compressed air port 2.

In a second step 2200, the method includes the control device 1300 activating the compressed air provider 200 in order to provide compressed air at the compressed air supply port 1 should the control device 1300 receive a supply requirement B_{V}.

The second step preferably further includes the control device 1300 regulating 2210, on the basis of the supply requirement (B_{V}), the supply pressure V_{P}) and/or the supply volumetric flow V_{V} of the compressed air 120′, 141′ that is to be provided at the pressure supply port 2.

The control device 1300 is signal-transmittingly connected to at least one pressure sensor 9 located in the pneumatic main line 12 and intended for providing sensor signals S concerning an input pressure P and to a pressure regulator 40 assigned to the pneumatic main line 12 and/or the compressed air port 1. The regulating of the supply pressure 2210 preferably includes the control device 1300 controlling 2212, on the basis of the sensor signals S, the pressure regulator 40 or the pneumatic assembly 20. In addition or as an alternative, the control device 1300 is signal-transmittingly connected to the electric motor 203, in particular BLDC electric motor 204, and the regulating of the supply pressure 2210 includes the control device 1300 regulating 2214 a motor speed M of the electric motor 203.

Furthermore, the activating of the compressor 201 in step 2200 preferably also includes activating, as and when required, an additional compressed air source 50, as shown in FIGS. 3 and 6B. Activating an additional compressed air source 50 is understood in the present case to mean connecting the compressed air source 50 to the pneumatic main line 12. An additional compressed air source 50, which can be an additional compressor 201.2 and/or a reservoir 51, increases the amount of compressed air available, that is, the volumetric flow available, and makes it possible to react to variable system requirements. In step 2220, the control device 1300 controls the compressed air source 50 on the basis of the supply requirement B_{V} of the compressed air consumer 300 and/or sensor information S detected by the temperature sensor 60, specifically a temperature T_{D} of the compressed air provider 200 or a degree of saturation G, monitored by the control device 1300, of one of the air dryers 5, 5.1, 5.2.

Furthermore, in a third step 2300 the method 2000 includes determining a risk of freezing R_{I}. The information I_{U} about the surrounding area preferably includes a current temperature T, a current humidity H of the surrounding area A, a climatic zone, an average temperature T_{A}, an average humidity H_{A} of the surrounding area A. It should be understood that the information I_{U} about the surrounding area may include one, several or all of them. The information I_{U} about the surrounding area is determined at a current location P₁ and/or along a route P and/or at a destination P₃. The method 2000 therefore includes, in a step 2310, determining the information I_{U} about the surrounding area or the control device 1300 retrieving the information I_{U} about the surrounding area in step 2320.

The method according to FIG. 7 further includes, should the risk of freezing R_{I} determined in step 2300 lie below a predefined limit value W, activating the main-line switching valve 25 (see FIG. 2A-3) in order to close off the pneumatic main line 12 in step 2400 and, in step 2500, conducting compressed air from the compressed air port 1 to the compressed air supply port 2 via the branch line 14, 14.1 (cf. FIG. 2A-5). If present, the branch-line switching valve 24 is additionally activated in step 2400.

The method further includes activating 2510 the pneumatic assembly 20 and preferably activating 2512 a throttle valve 21 according to FIGS. 6A and 6B in order to regulate the supply pressure V_{P} at the compressed air supply port 2.

Should the determined risk of freezing R_{I} reach or exceed a predefined limit value W, in step 3400 the main-line switching valve 25 is activated in the second operating mode B2 in order to open the pneumatic main line 12 to a pneumatic flow. Compressed air is thereupon conducted from the compressed air port 1 to the compressed air supply port 2 via the pneumatic main line 12 in step 3500.

The method further includes activating 3510 the pneumatic assembly 20 in order to distribute the compressed air 141 conducted in the branch line 14, 14.1, 14.2, for example on the basis of the supply requirement B _{V}, between the pneumatic main line 12, for return counter to the filling direction B, and the compressed air supply port 2. The activating 3510 of the pneumatic assembly 20 preferably includes activating 3512 a throttle valve 21 according to FIGS. 6A and 6B in order to regulate the supply pressure V_{P} at the compressed air supply port 2 or activating 3514 a return throttle valve 29, 29.1, 29.2 in order to regulate the pressure of the compressed air returned counter to the filling direction B.

The conducting of compressed air through the branch line in step 2500 or the conducting of compressed air through the pneumatic main line in step 3500 can preferably be a flushing of the pneumatic main line 12 and/or the branch line 14, 14.1 and/or the nozzle valves 302, 303 by way of compressed air 120′ provided at the compressed air port 1 and dried by the air dryer 5 and a draining of the compressed air via the venting line 13 in step 2600. This frees the pneumatic main line 12 and the branch line 14, 14.1 of residues and residual moisture. Subsequently, the method 2000 preferably includes activating the main-line switching valve 25 and the branch-line switching valve 24, 24.1 in order to pneumatically decouple the pneumatic main line 12 and the branch line from the compressed air port. Such a depressurizing of the compressed air supply system 100, that is, bringing of the compressed air supply unit 100 into an inactive mode, means that the pneumatic main line 12 and the branch line 14, 14.1, 14.2 are protected from frost damage. According to various embodiments, the flushing in a substep 2610 further includes activating the compressor venting valve 23.4 in order to vent a line volume between the compressed air provider 200 and the branch-line switching valve 24, 24.1, 24.2 and the main-line switching valve 25. As an alternative or in addition, the venting can also be carried out before activating the compressed air provider 200 in step 2200.

FIG. 8 shows a second embodiment of the method 4000 according to the disclosure.

The retrieving or determining in step 2310 also includes, in the method according to FIG. 8, retrieving location information I_{GPS} concerning the route P and/or the destination P₃ in step 2312. The location information I_{GPS} is preferably retrieved by an electrical system 1600 connected via a data interface 70 and/or by a navigation system 1700 (cf. FIG. 1). Similarly, the retrieving of the information I_{U} about the surrounding area in step 2320 may include retrieving current location information I_{GPS} in step 2322. It is also preferred for the retrieved temperature T and/or humidity H as information I_{U} about the surrounding area to concern a current temperature T or humidity H, respectively, of the surrounding area A, which are retrieved in a step 2324 by the control device 1300 from at least one signal-transmittingly connected ambient temperature sensor 410 and/or humidity sensor 400 (cf. FIG. 1) or from a signal-transmittingly connected electrical system 1700 (cf. FIG. 1).

The method 4000 further differs from the method 2000 shown previously in FIG. 7 in that, in a step 2800, the control device 1300 also determines a degree of saturation G of the first air dryer 5.1 and preferably of the second air dryer 5.2 on the basis of the information I_{U} about the surrounding area and/or the information I_{B} about the operating state. Furthermore, the risk of freezing R_{I} is determined on the basis of this information in a known way. Furthermore, the determining of the risk of freezing can include retrieving location information I_{GPS} concerning the route P and/or the destination P₃, in the known way. The information I_{B} about the operating state includes the operating duration t_{B} and the temperature T_{D} of the compressed air provider 200.

Depending on the determined degree of saturation G, in particular of the first air dryer 5.1 and the risk of freezing R_{I}, the control device 1300 is configured, should the risk of freezing R_{I} lie below a predefined limit value W, to activate the main-line switching valve 25 in order to close off the pneumatic main line 12 in the known way, the pressure supply system 1200 being operated in the first operating mode B1. Furthermore, the control device 1300 is configured to, in step 2410, also activate the first branch-line switching valve 24.1 in order to open up the first branch line 14.1 and, in step 2420, also activate the second branch-line switching valve 24.2, preferably in order to close off the second branch line 14.2. In step 2500, compressed air is then conducted from the compressed air port 1 to the compressed air supply port 2 via the first branch line.

Should the risk of freezing R_{I} reach or exceed the predefined limit value W and the degree of saturation G lie below a maximum degree of saturation Gₘₐₓ, the control device 1300 activates the main-line switching valve 25 in order to open up the pneumatic main line 12 in step 3400. According to various embodiments, the control device 1300 in this case also activates the first branch-line switching valve 24.1 in order to close off the first branch line 14.1 in step 3410 and the second branch line switching valve 24.2 in order to close off the second branch line 14.2 in step 3420. Then, in the second operating mode B2, compressed air is conducted via the pneumatic main line 12 from the compressed air port 1 to the compressed air supply port 2, the compressed air being dried by the first air dryer 5.1.

According to various embodiments, the method 4000 in the first operating mode further includes activating a first stop valve 32 (cf. FIG. 3), which is downstream of the first air dryer in the filling direction, in order to close off the pneumatic main line 12 in the first operating mode B1 should the risk of freezing R_{I} lie below the predefined limit value W in step 2900. According to various embodiments, the method 4000 in the first operating mode B1 includes activating the second stop valve 34 (cf. FIG. 3), which is downstream of the second air dryer 5.2 in the filling direction, in order to close off the pneumatic branch line 14.2 should the risk of freezing R_{I} lie below the predefined limit value W (step 2910). As a result, in the first operating mode the first air dryer 5.1 and the second air dryer 5.2 are also pneumatically decoupled from the first branch line 14.1 in a direction counter to the filling direction B, so that the air dryer 5.1, 5.2 in question does not become more saturated.

The control device 1300 is further configured, should the risk of freezing R_{I} reach or exceed the predefined limit value W and the degree of saturation G of the first air dryer 5.1 exceed a permissible maximum degree of saturation G_{max,} to activate the main-line switching valve 25 in step 4400 in order to close off the pneumatic main line 12. The control device 1300 is further configured in this case to close the first branch-line switching valve 24.1 in order to close off the first branch line 14.1 (step 4410) and preferably to activate the second branch-line switching valve 24.2 in order to open up the second branch line 14.2 in step 4420. The corresponding activating allows compressed air to then, in step 4500, be conducted from the compressed air port 1 to the compressed air supply port 2 via the second branch line 14.2 in the filling direction B and be dried by the second air dryer 5.2, the compressed air supply system 1200 being operated in the third operating mode B3.

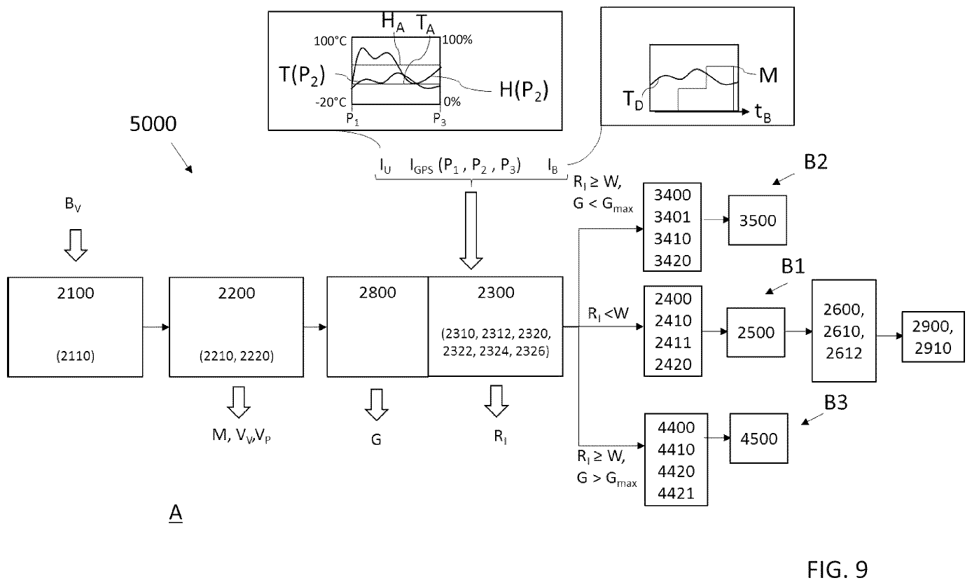

FIG. 9 shows a third embodiment of the method 5000 according to the disclosure for controlling a compressed air supply system 1200 as shown in FIG. 4. The main-line switching valve 25, the branch-line switching valve 24 or, selectively, also two branch-line switching valves, as shown in FIG. and FIG. 3, the compressor venting valve 23.4 and preferably also the first venting valve 23.1 are in the form of normally-closed 2/2 solenoid directional control valves. Identical or similar method steps have identical reference signs in this case; reference is made to the description of the method shown in FIG. 7 and only differences will be discussed. The method 5000 includes the first step 2100 to the ninth step 2900 of the method 4000 according to FIG. 8.

According to the method 5000, the activating 2610 of the compressor venting valve 23.4 in order to open up the compressor venting line 13.2 further includes energizing 2612 the compressor venting valve 23.4 with a heating current S_{I3}. Thus, the compressor venting valve 23.4 can firstly be heated before it is energized with an opening current S_{I1} in order to open up the compressor venting line 13.2 in step 2200. It is further also possible for the valves to be continuously energized with the heating current S_{I3} during operation and thus be heated.

Furthermore, the activating of the main-line switching valve 25 in the second operating mode B2 in step 3400 further includes energizing 3401 the main-line switching valve 25 with a heating current S_{I3}. Thus, the main-line switching valve 25 can firstly be heated before it is energized with an opening current S_{I1} in order to open up the pneumatic main line 12 in step 3400.

Furthermore, the activating of the first branch-line switching valve 24.1 (cf. FIG. 3) or the branch-line switching valve 24.1 (cf. FIG. 4) in the first operating mode B1 in step 2410 in order to open up the (first) branch line 14, 14.1 further includes energizing 2411 the (first) branch-line switching valve 24, 24.1 with a heating current S_{I3}. Thus, the (first) branch-line switching valve 24, 24.1 can firstly be heated before it is energized with an opening current S_{I1} in order to open up the (first) branch line 14, 14.1 in step 2410.

Furthermore, the activating 4420 of a second branch-line switching valve 24.2 in the third operating mode B3 in step 4420 further includes energizing the second branch-line switching valve 24.2 with a heating current S_{I3} in step 4421. Thus, the second branch-line switching valve 24.2 can firstly be heated before it is energized with an opening current S_{I1} in order to open up the second branch line 14.2 in step 4420.

Correspondingly, a heating current S_{I3} can also firstly be applied to the venting valve 23.1 before applying an opening current S_{I1}.

Thus, all of the solenoid directional control valves can be heated before they are energized with an opening current S_{I1} in order to open up the flow path in question.

When determining the risk of freezing R_{I} on the basis of the information I_{U} about the surrounding area and/or the information I_{B} about the operating state of the compressed air provider 200 in step 2300, the control device 1300 determines a reduced risk of freezing R_{I2} in step 2326, since the control device 1300 is configured to apply a heating control current S_{I3} and the solenoid valves 23.1, 23.4, 24, 24.1, 24.2, 25 and the nozzle valves 302, 303 are thus protected from frost damage even at temperatures close to freezing.

In the context of the disclosure, it should be understood that the first operating mode B1 denotes a bypass mode, in which compressed air which is not dried or is only partially dehumidified by the water separator 6 is conveyed to the compressed air supply port 2. The second operating mode B2 relates to a basic operating mode in which compressed air dried by the (first) air dryer 5, 5.1 is conveyed to the compressed air supply port 2. The third operating mode B3 relates to an alternative drying operating mode in which compressed air for the compressed air consumer 300 and/or for regenerating the first air dryer 5.1 is conducted through the second air dryer 5.2.

It is understood that the foregoing description is that of the preferred embodiments of the invention and that various changes and modifications may be made thereto without departing from the spirit and scope of the invention as defined in the appended claims.

### REFERENCE SIGNS (PART OF THE DESCRIPTION)

1 Compressed air port
2 Compressed air supply port
3 Venting port
5 Air dryer
5.1 First air dryer
5.2 Second air dryer
6 Water separator
8 Throttle
8.1 First throttle
8.2 Second throttle
9 Pressure sensor
12 Pneumatic main line
13 Venting line
13.1 First venting line
13.2 Second venting line
13.3 Compressor venting line
14 Branch line
14.1 First branch line
14.2 Second branch line
15 Bypass line
16 Condensation dryer
20 Pneumatic assembly
21 Throttle valve in pneumatic main line
21A Throttle point
21B Control pressure line
23 Venting valve assembly
23.1 First venting valve
23.2 Venting check valve
23.3 Second venting valve
23.4 Compressor venting valve
23.5 Control valve
23.5AControl line
23.5BBypass
23.5CLine
24 Switching valve
24.1 First branch-line switching valve
24.2 Second branch-line switching valve
25 Pneumatic switching valve
26 Separating member
27, 27.1, 27.2 First check valve
28, 28.1, 28.2 Second check valve
29, 29.1, 29.2 Return throttle valve
32 First stop valve
34 Second stop valve
36 Ventilation unit
40 Pressure regulator
50 Compressed air source
51 Reservoir
52 Reservoir switching valve
53 Reservoir pressure sensor
60 Temperature sensor
70 Data interface
71 Data bus
72 CAN bus
100 Compressed air supply unit
101 Pressure control module
110 Compressed air at the compressed air port
120 Partially dehumidified compressed air in pneumatic main line
120′ Dried compressed air in pneumatic main line
131 Humid compressed air in venting line
141 Compressed air in/from first branch line
141′ Pressure-relieved compressed air from first branch line
200 Compressed air provider
201 Compressor
203 Electric motor
204 BLDC electric motor
300 Compressed air consumer
301 Sensor cleaning device
302 First nozzle valve
303 Second nozzle valves
304 2/2-way valve
305 Magnetic part
306 Pneumatic part
307 Coil
308 Armature
309 Air gap
310 First compressed air passage
311 Second compressed air passage
312 Valve plunger part
313 Impact surface
314 Valve spring
315 Valve seat
400 Humidity sensor
410 Ambient temperature sensor
1000 Vehicle
1100 Passenger car
1200 Compressed air supply system
1300 Control unit
1310 Computing equipment
1320 Processor
1400 Front region of the vehicle
1600 Electrical system
1610 Electrical-system memory
1620 Electrical-system battery
1700 Navigation system
2000, 4000, 5000Method
2100 Receiving a supply requirement
2110 Receiving and determining a supply pressure and/or a supply volumetric flow
2200 Activating a compressed air provider
2210 Regulating the supply pressure and/or supply volumetric flow
2220 Activating an additional compressed air source
2300 Determining a risk of freezing
2310 Determining information about the surrounding area
2320 Retrieving information about the surrounding area
2312, 2322Retrieving location information and location about the surrounding area
2324 Retrieving the current temperature and/or humidity
2326 Determining a reduced risk of freezing
2400 Activating a main-line switching valve in the first operating mode
2410 Activating a first branch-line switching valve in the first operating mode
2411 Energizing the (first) branch-line switching valve with a heating current
2420 Activating a second branch-line switching valve in the first operating mode
2500 Conducting compressed air through the (first) branch line
2510 Activating the pneumatic assembly
2512 Activating the throttle valve
2600 Flushing the pneumatic main line
2610 Activating the compressor venting valve for venting purposes
2612 Energizing the compressor venting valve with a heating current
2700 Pneumatic decoupling
2800 Determining a degree of saturation
2900 Activating a first stop valve
2910 Activating a second stop valve
2101 Pre-filling the pneumatic main line
2102 Opening up the pre-filled pneumatic main line
3400 Activating the main-line switching valve in the second operating mode
3401 Energizing the main-line switching valve with a heating current
3410 Activating a first branch-line switching valve in the second operating mode
3420 Activating a second branch-line switching valve in the second operating mode
3500 Returning compressed air through the pneumatic main line
3512 Activating the throttle valve
4400 Activating a second branch-line switching valve in the third operating mode
4410 Activating a first branch-line switching valve in the third operating mode

### 4420 Activating a Main-line Switching Valve in the Third Operating Mode

4421 Energizing the second branch-line switching valve with a heating current
4500 Conducting compressed air through the (second) branch line
S1 First signal line
S2 Second signal line
S3 Third signal line
S4 Fourth signal line
S5 Fifth signal line
S6 Sixth signal line
S6.1 CAN bus connection
S7 Seventh signal line
S8 Eighth signal line
S9 Ninth signal line
S10 Tenth signal line
F Direction of travel
B Filling direction
R Return direction
E Venting direction
B1 First operating mode
B2 Second operating mode
B3 Third operating mode
K Condensate
P Input pressure, sensor information
P_{V} Supply pressure
V_{V} Supply volumetric flow
B_{V} Supply requirement
H Humidity, sensor information
T Temperature, sensor information
H_{A} Average humidity
T_{A} Average temperature
T_{D} Temperature of the compressed air provider
S Sensor signal
G Degree of saturation
G_{Max} Maximum degree of saturation
M Motor speed
I_{GPS} Location information
I_{U} Information about the surrounding area
T_{B} Operating duration
I Current
W Limit value
V_{L} Line volume
F_{F} Spring force
F_{M} Magnetic force
S_{I} Control current
S_{I1} Opening control current
S_{I2} Holding control current
S_{I3} Heating control current
P_{S} Control pressure
Q Flow cross section
R_{I} Risk of freezing
R_{I′} Reduced risk of freezing
P₁ Current location
P Route
P₃ Destination

1. A method for controlling a compressed air supply system for a vehicle wherein the compressed air supply system is assigned a control device in order to supply a compressed air consumer via a compressed air supply port and the compressed air supply system has a compressed air provider for providing compressed air at a compressed air port, a pneumatic main line which has an air dryer for drying compressed air and conducting same to the compressed air supply port in a filling direction, and a branch line which branches off from the pneumatic main line upstream of the air dryer in the filling direction and rejoins the pneumatic main line downstream of the air dryer in the filling direction, the method comprising:
receiving, at the control device, a supply requirement of the compressed air consumer; activating, via the control device, the compressed air provider in order to provide compressed air at the compressed air port should the control device receive the supply requirement;
determining, via the control device, a risk of freezing on a basis of at least one of information about a surrounding area and information about an operating state of the compressed air provider;
activating, via the control device, a main-line switching valve in order to close off the pneumatic main line in a first operating mode should the risk of freezing be below a predefined limit value; and,
conducting the compressed air through the branch line to the compressed air supply port in the filling direction in the first operating mode to supply the compressed air consumer.

2. The control method of claim 1 further comprising:
activating, via the control device, the main-line switching valve in order to open up the pneumatic main line in a second operating mode should the risk of freezing reach or exceed the predefined limit value; and,
conducting the compressed air through the pneumatic main line to the compressed air supply port in the filling direction on the basis of the supply requirement and the air dryer drying the compressed air in the second operating mode.

3. The control method of claim 1, wherein said determining the risk of freezing further includes the control device determining and/or retrieving the information about the surrounding area.

4. The control method of claim 3, wherein the information about the surrounding area includes at least one of:
a current temperature of the surrounding area;
a current humidity of a surrounding area;
a climatic zone;
an average temperature of the surrounding area; and,
an average humidity of the surrounding area.

5. The control method of claim 2 further comprising:
determining the information about the surrounding area at least one of:
at a current location, along a route, and or at a destination; and,
wherein said determining the information about the surrounding area includes retrieving location information concerning at least one of the route and the destination from at least one of an electrical system connected via a data interface and a navigation system.

6. The control method of claim 4, wherein at least one of the temperature and the humidity include at least one of a current temperature and a humidity of the surrounding area, and said retrieving the information about the surrounding area includes the control device retrieving at least one of the current temperature and the humidity from at least one of a signal-transmittingly connected ambient temperature sensor and a humidity sensor or from a signal-transmittingly connected electrical system.

7. The control method of claim 6, wherein the risk of freezing lies below the predefined limit value should the information about the surrounding area meet at least one of:
the humidity is at most 1 g/m3;
the temperature of the surrounding area is at least 15° C;
the temperature of the surrounding area is at least 20° C;
the average temperature is at least 20° C;
the average humidity is at most 0.5 g/m3;
the average humidity is at most 0.25 g/m3; and,
the climatic zone is tropical or subtropical.

8. The control method of claim 1, wherein the information about the operating state includes at least one of:
an operating duration of at least one of the compressed air provider and an electric motor, the operating duration being monitored by the control device via at least one of a signal-transmitting connection and a CAN bus connection; and,
a temperature of at least one of the compressed air provider and the electric motor, the temperature being measured directly or indirectly by at least one temperature sensor and monitored by the control device.

9. The control method of claim 8, wherein the risk of freezing lies below the predefined limit value should at least the information about the operating state meet at least one of:
the operating duration of the compressed air provider within 15 minutes is at least 5 minutes; and,
the temperature of the compressed air provider is at least 60° C.

10. The control method of claim 2 further comprising activating a branch-line switching valve in order to close off the branch line in the filling direction in the second operating mode should the risk of freezing exceed the predefined limit value.

11. The control method of claim 10, wherein the method further comprises at least one of the following steps:
flushing at least one of the pneumatic main line counter to the filling direction and the branch line in the filling direction by way of the compressed air provided at the compressed air port and dried by the air dryer, and draining the compressed air via a venting line;
flushing the compressed air consumer by way of the compressed air provided at the compressed air port and dried by the air dryer, and draining the compressed air via the compressed air consumer; and,
activating the main-line switching valve and the branch-line switching valve in order to pneumatically decouple at least one of the branch line and the pneumatic main line from the compressed air port.

12. The control method of claim 1, wherein the compressed air supply system has a pneumatic assembly assigned to the compressed air supply port and signal-transmittingly connected to the control device, the method further comprising at least one of:
pre-filling at least one of the pneumatic main line and the branch line with the compressed air via the compressed air port, wherein the pneumatic assembly pneumatically decouples at least one of the pneumatic main line, the branch line, and the compressed air supply port from the compressed air consumer; and,
activating the pneumatic assembly to open up at least one of the compressed air supply port and the pneumatic main line after said pre-filling of the pneumatic main line.

13. The control method of claim 1, wherein the branch line is a first branch line with a first branch-line switching valve, the air dryer is a first air dryer, and the compressed air supply system further has a second branch line with a second branch-line switching valve and a second air dryer, the method further comprising:
determining, via the control device, a degree of saturation of the first air dryer and on the basis of the information about the surrounding area and/or the information about the operating state;
activating, via the control device, the second branch-line switching valve in order to open up the second branch line in a third operating mode should the risk of freezing reach or exceed the predefined limit value and the degree of saturation of the first air dryer reach a maximum degree of saturation; and,
conducting the compressed air through the second branch line to the compressed air supply port in a filling direction on the basis of the supply requirement and the second air dryer drying the compressed air in the third operating mode.

14. The control method of claim 13 further comprising determining, via the control device, a second degree of saturation of the second air dryer on the basis of at least one of the information about the surrounding area and the information about the operating state.

15. The control method of claim 13 further comprising at least one of:
activating a first stop valve, which is downstream of the first air dryer in the filling direction, in order to close off the pneumatic main line in the first operating mode should the risk of freezing lie below the predefined limit value;
activating a second stop valve, which is downstream of the second air dryer in the filling direction, in order to close off the second branch line in the first operating mode should the risk of freezing lie below the predefined limit value;
activating the second branch-line switching valve in order to close off the second branch line in the second operating mode; and,
activating the first branch-line switching valve in order to close off the first branch line in the third operating mode.

16. The control method of claim 1, the method, after said receiving of the supply requirement, further comprising:
determining, via the control device, on the basis of the supply requirement, at least one of a supply pressure and a supply volumetric flow of the compressed air that is to be provided at the compressed air supply port;
regulating, via the control device, on the basis of the supply requirement, at least one of the supply pressure and the supply volumetric flow of the compressed air provided at the compressed air supply port;
wherein at least one of:
the control device is signal-transmittingly connected to at least one pressure sensor, located in the pneumatic main line, in order to provide sensor signals and to a pressure regulator assigned to the pneumatic main line and/or to the compressed air port, and said regulating of the supply pressure includes controlling, via the control device, the pressure regulator on a basis of the sensor signals, and,
the control device is signal-transmittingly connected to an electric motor, wherein said regulating of the supply pressure includes the control device regulating a motor speed of the electric motor.

17. The control method of claim 1, wherein the control device is connected to a pneumatic assembly associated with the compressed air supply port, the method further comprising at least one of:
controlling, via the control device, the pneumatic assembly on a basis of at least one of sensor signals from a temperature sensor assigned to the compressed air provider and on the supply requirement; and,
activating an additional compressed air source on the basis of at least one of the supply requirement of the air dryer and the sensor signal from the temperature sensor assigned to the compressed air provider.

18. The control method of claim 1, wherein at least one of: at least one branch-line switching valve, at least one main-line switching valve, at least one nozzle valve of a sensor cleaning device connected to the compressed air supply unit, at least one venting valve, and a compressor venting valve is a normally closed solenoid directional control valve, the method further comprising:
selectively energizing, with an opening control current and a heating control current, at least one of:
the at least one branch-line switching valve;
the at least one main-line switching valve;
the at least one nozzle valve of the sensor cleaning device connected to the compressed air supply unit;
the at least one venting valve; and,
the compressor venting valve.

19. The control method of claim 17, wherein the control device, when determining the risk of freezing on the basis of at least one of the information about the surrounding area and the information about the operating state of the compressed air provider, determines a reduced risk of freezing should the control device be configured to apply a heating control current.

20. The control method of claim 1, wherein the vehicle is a passenger car.

21. The control method of claim 1, wherein said activating via the control device the compressed air provider includes activating an electric motor assigned to the compressed air provider.

22. A control device for controlling a compressed air supply system for a vehicle, wherein the control device is assigned to the compressed air supply system for supplying a compressed air consumer via a compressed air supply port and the compressed air supply system has a compressed air provider for providing compressed air at a compressed air port, a pneumatic main line which has an air dryer for drying compressed air and conducting same to the compressed air supply port in a filling direction, and a branch line which branches off from the pneumatic main line upstream of the air dryer in the filling direction and rejoins the pneumatic main line downstream of the air dryer in the filling direction, the control device comprising:
a controller configured to determine a risk of freezing on a basis of at least one of information about a surrounding area and information about an operating state of the compressed air provider and to activate a main-line switching valve in order to close off the pneumatic main line in a first operating mode should the risk of freezing lie below a predefined limit value.

23. The control device of claim 22, wherein the vehicle is a passenger car.

24. A vehicle comprising:
a compressed air supply system for supplying a compressed air consumer via a compressed air supply port;
the compressed air supply system having a compressed air provider for providing compressed air at a compressed air port, a pneumatic main line which has an air dryer for drying the compressed air and conducting same to the compressed air supply port in a filling direction, and a branch line which branches off from the pneumatic main line upstream of the air dryer in the filling direction and rejoins the pneumatic main line downstream of the air dryer in the filling direction;
a control device assigned to the compressed air supply system;
the control device being configured to determine a risk of freezing on a basis of at least one of information about a surrounding area and information about an operating state of the compressed air provider and to activate a main-line switching valve in order to close off the pneumatic main line in a first operating mode should the risk of freezing lie below a predefined limit value; and,
the compressed air consumer being connected to the compressed air supply port.

25. The vehicle of claim 24, further comprising at least one of:
at least one sensor which is signal-transmittingly connected to the control device and configured to provide sensor information for determining at least one of a degree of saturation of the air dryer and a permissible moisture; and,
at least one data interface which is signal-transmittingly connected to the control device and is configured to provide stored sensor information for determining at least one of the degree of saturation of the air dryer and the permissible moisture.

26. The vehicle of claim 24 further comprising:
an electrical system connected to the control device via the data interface and being configured to provide at least one of: location information from a navigation system, information about the surrounding area that is associated with the location information, stored sensor information from a memory of the electrical system, and sensor information from at least one sensor connected to the electrical system; and,
a battery of the electrical system, this battery being configured to supply current to at least one of the electrical system, the compressed air provider, the compressed air consumer, and the control device;
wherein the control device is configured to determine, on a basis of at least one of the provided sensor information, location information, the information about the surrounding area, a temperature of the surrounding area, a forecast temperature of the surrounding area, the current humidity of the surrounding area, and a forecast humidity of the surrounding area, at least at one of: a current location, along a route and at a destination.

27. The vehicle of claim 24, wherein at least one of:
the vehicle is a passenger car; and,
the compressed air consumer is a sensor cleaning device.

28. The vehicle of claim 25, wherein the at least one data interface is at least one of a bus and a CAN bus.

29. The method of claim 26, wherein the at least one sensor is an ambient temperature sensor and a humidity sensor.
